(19) United States
(12) Patent Application Publication
(10) Pub. No.: US 2015/0195554 A1
(43) Pub. Date: Jul. 9, 2015

(54) CONSTRAINTS AND ENHANCEMENTS FOR A SCALABLE VIDEO CODING SYSTEM

(71) Applicant: Sharp Laboratories of America, Inc., Camas, WA (US)

(72) Inventors: Kiran MISRA, Camas, WA (US); Sachin G. DESHPANDE, Camas, WA (US); Christopher A. SEGALL, Vancouver, WA (US)

(21) Appl. No.: 14/588,968

(22) Filed: Jan. 4, 2015

Related U.S. Application Data
(60) Provisional application No. 61/923,557, filed on Jan. 3, 2014.
(60) Provisional application No. 61/924,609, filed on Jan. 7, 2014.

(51) Int. Cl. H04N 19/44; H04N 19/30

(52) U.S. Cl. CPC H04N 19/44; H04N 19/30

(57) ABSTRACT

A system for decoding a video bitstream that includes constraints for scalable video coding.

### CROSS-REFERENCE TO RELATED APPLICATIONS

This application claims the benefit of U.S. Provisional App. No. 611923,557, filed Jan. 3, 2014 and U.S. Provisional App. No. 611924,609, filed Jan. 7, 2014.

### TECHNICAL FIELD

The present disclosure relates generally to electronic devices. More specifically, the present disclosure relates to electronic devices for signaling sub-picture based hypothetical reference decoder parameters.

### BACKGROUND OF THE INVENTION

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and displaying digital media. For example, portable electronic devices now allow for digital media to be consumed at almost any location where a consumer may be. Furthermore, some electronic devices may provide download or streaming of digital media content for the use and enjoyment of a consumer.

The increasing popularity of digital media has presented several problems. For example, efficiently representing high-quality digital media for storage, transmittal and rapid playback presents several challenges. As can be observed from this discussion, systems and methods that represent digital media efficiently with improved performance may be beneficial.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1A is a block diagram illustrating an example of one or more electronic devices in which systems and methods for sending a message and buffering a bitstream may be implemented;

FIG. 1B is another block diagram illustrating an example of one or more electronic devices in which systems and methods for sending a message and buffering a bitstream may be implemented;

FIG. 2 is a flow diagram illustrating one configuration of a method for sending a message;

FIG. 3 is a flow diagram illustrating one configuration of a method for determining one or more removal delays for decoding units in an access unit;

FIG. 4 is a flow diagram illustrating one configuration of a method for buffering a bitstream;

FIG. 5 is a flow diagram illustrating one configuration of a method for determining one or more removal delays for decoding units in an access unit;

FIG. 6A is a block diagram illustrating one configuration of a decoder on an electronic device;

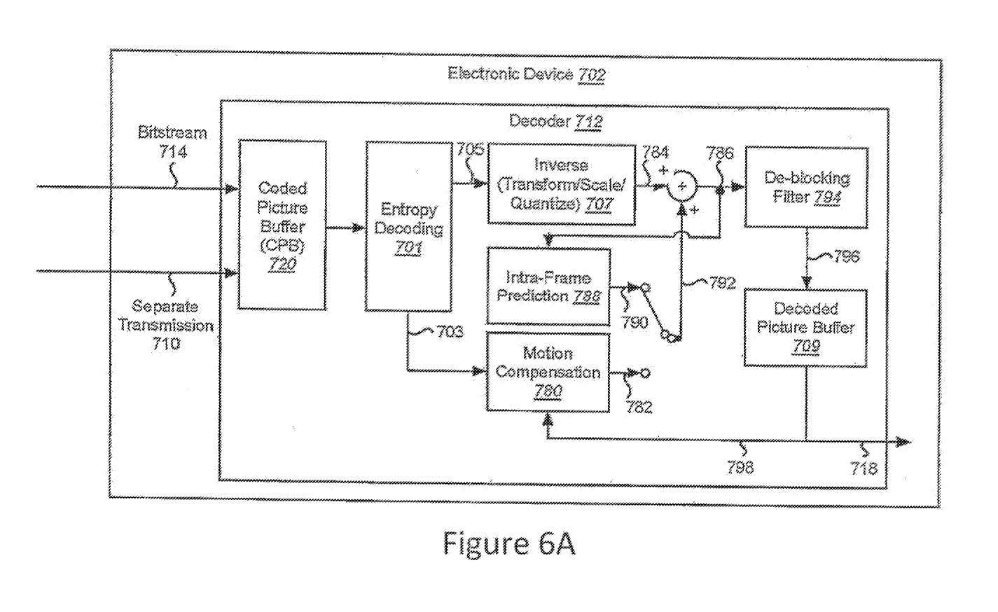

FIG. 6B is another block diagram illustrating one configuration of a decoder on an electronic device;

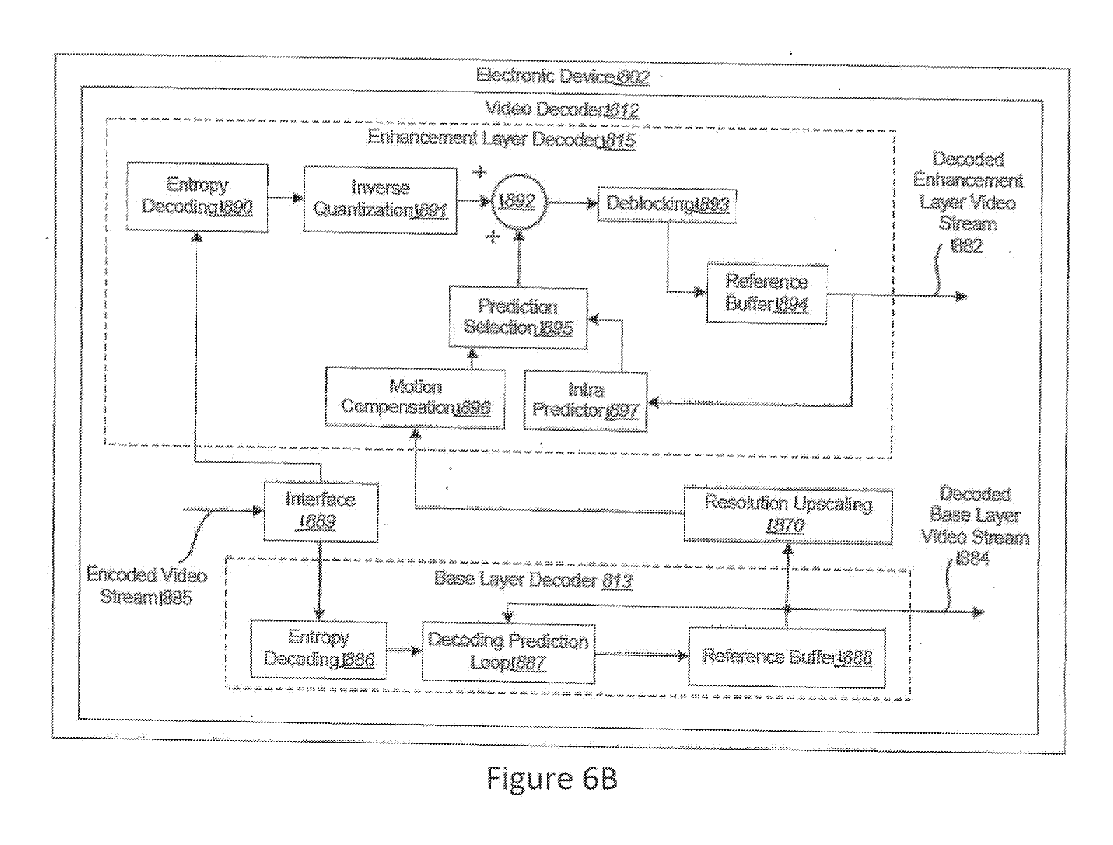

FIG. 7 is a block diagram illustrating one configuration of a method for operation of a decoded picture buffer,

FIG. 8 illustrates a general NAL Unit syntax.

FIG. 9 illustrates an exemplary upsampling with the same spatial scaling factor for both luma and chroma.

FIG. 10 illustrates an exemplary upsampling with different spatial scaling factor for different color components,

FIG. 11 illustrates an exemplary alignment of IDR pictures between the auxiliary picture and the associated primary picture layers.

FIG. 12 illustrates an exemplary alignment of 1RAP pictures between the auxiliary picture and the associated primary picture layers.

### DEFINITIONS AND NOTATIONS

Ceil(x) Represents the Smallest Integer Greater than or Equal to x

Log2(x) represents the base-2 logarithm of x

The following relational operators are defined as follows:

> Greater than.
>= Greater than or equal to.
< Less than.
<= Less than or equal to.

### == Equal to.

!= Not equal to.

The following logical operators are defined as folio

x && y Boolean logical “and” of x and y.
x||y Boolean logical “or” of x and y.
! Boolean logical “not”.

x?y:z If x is TRUE or not equal to 0, evaluates to the value of y; otherwise, evaluates to the value of z.

& Bit-wise “and”. When operating on integer arguments, operates on a two's complement representation of the integer value. When operating on a binary argument that contains fewer bits than another argument, the shorter argument is extended by adding more significant bits equal to 0.
| Bit-wise “or”. When operating on integer arguments, operates on a two's complement representation of the integer value. When operating on a binary argument that contains fewer bits than another argument, the shorter argument is extended by adding more significant bits equal to 0,
´Bit-wise “exclusive or”. When operating on integer arguments, operates on a two's complement representation of the integer value. When operating on a binary argument that contains fewer bits than another argument, the shorter argument is extended by adding more significant bits equal to 0.
x>>y Arithmetic right shift of a two's complement integer representation of x by y binary digits. This function is defined only for non-negative integer values of y. Bits shifted into the MSBs as a result of the right shift have a value equal to the MSB of x prior to the shift operation.
x<<y Arithmetic left shift of a two's complement integer representation of x by y binary digits. This function is defined only for non-negative integer values of y. Bits shifted into the LSBs as a result of the left shift have a value equal to 0.
=Assignment operator.
++□ Increment, i.e. x□□ is equivalent to x□x□1; when used in an array index, evaluates to the value of the variable prior to the increment operation.
−− Decrement, i.e. x−− is equivalent to x□x−1; when used in an array index, evaluates to the value of the variable prior to the decrement operation.
+= Increment by amount specified, i.e. x+=3 is equivalent to x=x+3, and
x+=(−3) is equivalent to x=x+(−3).
−= Decrement by amount specified, i.e. x−=3 is equivalent to x=x−3, and x−=(−3) is equivalent to x=x−(−3).

### + Addition

− Subtraction (as a two-argument operator) or negation (as a unary prefix operator)
* Multiplication, including matrix multiplication
x^{y} Exponentiation. Specifies x to the power of y. In other contexts, such notation is used for superscripting not intended for interpretation as exponentiation.
/ integer division with truncation of the result toward zero. For example, 7/4 and −7/−4 are truncated to 1 and −7/4 and 7/−4 are truncated to −1.
÷ Used to denote division in mathematical equations where no truncation or rounding is intended.
x/y Used to denote division in mathematical equations where no truncation or rounding is intended.

$${\sum }_{i = x}^{y} f ( i )$$

The summation of f(i) with i taking all integer values from x up to and including y.
x % y Modulus. Remainder of x divided by y, defined only for integers x and y with x>=0 and y>0.

An auxiliary picture is a picture that has no normative effect on the decoding process of primary pictures.

The source and decoded pictures are each comprised of one or more sample arrays:
Luma (Y) only (monochrome).
Luma and two chrome (YCbCr or YCgCo).
Green, Blue and Red (GBR, also known as ROB).
Arrays representing other unspecified monochrome or tri-stimulus colour samplings (for example, YZX, also known as XYZ).
   The variables and terms associated with these arrays are referred to as lura (or L or Y) and chrome, where the two chrome arrays are referred to as Cb and Cr; regardless of the actual colour representation method in use.
   The variables SubWidthC, and SubHeightC are specified in Table (A), depending on the chrome format sampling structure, which is specified through chroma_format_idc and separate_colour_plane_flag syntax elements.

TABLE (A)

| | | | Sub- | Sub- |
|---|---|---|---|---|
| chroma_format_{—} | separate_colour_plane_{—} | Chroma | Width | Height |
| idc | flag | format | C | C |
| 0 | 0 | mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

In monochrome sampling there is only one sample array, which is nominally considered the luma array.
In 4:2:0 sampling, each of the two chrorna arrays has half the height and half the width of the luma array.
In 4:2:2 sampling, each of the two chroma arrays has the same height and half the width of the luma array.ln 4:4:4 sampling, depending on the value of separate_colour_plane_flag, the following applies:
If separate_colour_plane_flag is equal to 0, each of the two chrorna arrays has the same height and width as the luma array.
Otherwise (separate_colour_planejlag is equal to 1), the three colour planes are separately processed as monochrome sampled pictures.

### DETAILED DESCRIPTION OF PREFERRED EMBODIMENT

An electronic device for sending a message is described. The electronic device includes a processor and instructions stored in memory that is in electronic communication with the processor. The electronic device determines, when a Coded Picture Buffer (CPB) supports operation on a sub-picture level, whether to include a common decoding unit CPB removal delay parameter in a picture timing Supplemental Enhancement Information (SEI) message. The electronic device also generates, when the common decoding unit CPB removal delay parameter is to be included in the picture timing SEI message (or some other SEI message or some other parameter set e.g. picture parameter set or sequence parameter set or video parameter set or adaptation parameter set), the common decoding unit CPB removal delay parameter, wherein the common decoding unit CPB removal delay parameter is applicable to all decoding units in an access unit from the CPB, The electronic device also generates, when the common decoding unit CPB removal delay parameter is not to be included in the picture timing SEI message, a separate decoding unit CPB removal delay parameter for each decoding unit in the access unit. The electronic device also sends the picture timing SEI message with the common decoding unit CPB removal delay parameter or the decoding unit CPB removal delay parameters.

The common decoding unit CPB removal delay parameter may specify an amount of sub-picture clock ticks to wait after removal from the CPB of an immediately preceding decoding unit before removing from the CPB a current decoding unit in the access unit associated with the picture timing SEI message.

Furthermore, when a decoding unit is a first decoding unit in an access unit, the common decoding unit CPB removal delay parameter may specify an amount of sub-picture dock ticks to wait after removal from the CPB of a last decoding unit in an access unit associated with a most recent buffering period SEI message in a preceding access unit before removing from the CPB the first decoding unit in the access unit associated with the picture timing SEI message.

In contrast, when the decoding unit is a non-first decoding unit in an access unit, the common decoding unit CPB removal delay parameter may specify an amount of sub-picture dock ticks to wait after removal from the CPB of a preceding decoding unit in the access unit associated with the picture timing SEI message before removing from the CPB a current decoding unit in the access unit associated with the picture timing BEI message.

The decoding unit CPB removal delay parameters may specify an amount of sub-picture clock ticks to wait after removal from the CPB of the last decoding unit before removing from the CPB an i-th decoding unit in the access unit associated with the picture timing SEI message.

The electronic device may calculate the decoding unit CPB removal delay parameters according to a remainder of a modulo 2^{(cpb}^{_{—}}^{removal}^{_{—}}^{delay}^{_{—}}^{length}^{_{—}}^{minus1+1)} counter where cpb_removal_delay_length_minus1+1 is a length of a common decoding unit CPB removal delay parameter.

The electronic device may also generate, when the CPB supports operation on an access unit level, a picture timing SEI message including a CPB removal delay parameter that specifies how many clock ticks to wait after removal from the CPB of an access unit associated with a most recent buffering period SEI message in a preceding access unit before removing from the CPB the access unit data associated with the picture timing SEI message.

The electronic device may also determine whether the CPB supports operation on a sub-picture level or an access unit level. This may include determining a picture timing flag that indicates whether a Coded Picture Buffer (CPB) provides parameters supporting operation on a sub-picture level based on a value of the picture timing flag. The picture timing flag may be included in the picture timing SEI message.

Determining whether to include a common decoding unit CPB removal delay parameter may include setting a common decoding unit CPB removal delay flag to 1 when the common decoding unit CPB removal delay parameter is to be included in the picture timing SEI message. It may also include setting the common decoding unit CPB removal delay flag to 0 when the common decoding unit CPB removal delay parameter is not to be included in the picture timing SEI message. The common decoding unit CPB removal delay flag may be included in the picture timing SEI message.

The electronic device may also generate, when the CPB supports operation on a sub-picture level, separate network abstraction layer (NAL) units related parameters that indicate an amount, offset by one, of NAL units for each decoding unit in an access unit. Alternatively, or in addition to, the electronic device may generate a common NAL parameter that indicates an amount, offset by one, of NAL units common to each decoding unit in an access unit.

An electronic device for buffering a bitstream is also described. The electronic device includes a processor and instructions stored in memory that is in electronic communication with the processor. The electronic device determines that a CPB signals parameters on a sub-picture level for an access unit. The electronic device also determines, when a received picture timing Supplemental Enhancement Information (SEI) message comprises the common decoding unit Coded Picture Buffer (CPB) removal delay flag, a common decoding unit CPB removal delay parameter applicable to all decoding units in the access unit. The electronic device also determines, when the picture timing SEI message does not comprise the common decoding unit CPB removal delay flag, a separate decoding unit CPB removal delay parameter for each decoding unit in the access unit. The electronic device also removes decoding units from the CPB using the common decoding unit CPB removal delay parameter or the separate decoding unit CPB removal delay parameters. The electronic device also decodes the decoding units in the access unit.

A method for sending a message by an electronic device is also described. The method includes determining, when a Coded Picture Buffer (CPB) supports operation on a sub-picture level, whether to include a common decoding unit CPB removal delay parameter in a picture timing Supplemental Enhancement Information (SEI) message. The method also includes generating, when the common decoding unit CPB removal delay parameter is to be included in the picture timing SEI message, the common decoding unit CPB removal delay parameter, wherein the common decoding unit CPB removal delay parameter is applicable to all decoding units in an access unit from the CPB. The method also includes generating, when the common decoding unit CPB removal delay parameter is not to be included in the picture timing SEI message, a separate decoding unit CPB removal delay parameter for each decoding unit in the access unit. The method also includes sending the picture timing SEI message with the common decoding unit CPB removal delay parameter or the decoding unit CPB removal delay parameters.

A method for buffering a bitstream by an electronic device is also described. The method includes determining that a CPB signals parameters on a sub-picture level for an access unit. The method also includes determining, when a received picture timing Supplemental Enhancement Information (SEI) message comprises the common decoding unit Coded Picture Buffer (CPB) removal delay flag, a common decoding unit CPB removal delay parameter applicable to all decoding units in the access unit. The method also includes determining, when the picture timing SEI message does not comprise the common decoding unit CPB removal delay flag, a separate decoding unit CPB removal delay parameter for each decoding unit in the access unit. The method also includes removing decoding units from the CPB using the common decoding unit CPB removal delay parameter or the separate decoding unit CPB removal delay parameters, The method also includes decoding the decoding units in the access unit.

The systems and methods disclosed herein describe electronic devices for sending a message and buffering a bitstream. For example, the systems and methods disclosed herein describe buffering for bitstreamns starting with sub-picture parameters. In some configurations, the systems and methods disclosed herein may describe signaling sub-picture based Hypothetical Reference Decoder (HRD) parameters. For instance, the systems and methods disclosed herein describe modification to a picture timing Supplemental Enhancement Information (SEI) message. The systems and methods disclosed herein (e.g., the HRD modification) may result in more compact signaling of parameters when each sub-picture arrives and is removed from CPB at regular intervals.

Furthermore, when the sub-picture level CPB removal delay parameters are present, the Coded Picture Buffer (CPB) may operate at access unit level or sub-picture level. The present systems and methods may also impose a bitstream constraint so that the sub-picture level based CPB operation and the access unit level CPB operation result in the same timing of decoding unit removal. Specifically the timing of removal of last decoding unit in an access unit when operating in sub-picture mode and the timing of removal of access unit when operating in access unit mode will be the same.

It should be noted that although the term “hypothetical” is used in reference to an HRD, the HRD may be physically implemented. For example, “HRD” may be used to describe an implementation of an actual decoder. In some configurations, an HRD may be implemented in order to determine whether a bitstream conforms to High Efficiency Video Coding (HEVC) specifications. For instance, an HRD may be used to determine whether Type I bitstreams and Type H bitstreams conform to HEVC specifications. A Type I bitstream may contain only Video Coding Layer (VCL) Network Access Layer (NAL) units and filler data NAL units. A Type H bitstream may contain additional other NAL units and syntax elements.

Joint Collaborative Team on Video Coding (JCTVC) document JCTVC-I0333 includes sub-picture based HRD and supports picture timing SEI messages. This functionality has been incorporated into the High Efficiency Video Coding (HEVC) Committee Draft (JCTVC-I1003), incorporated by reference herein in its entirety. B. Bross, W-J. Han, J-R. Ohm, G. J. Sullivan, Wang, and T-. Wiegand, “High efficiency video coding (HEVC) text specification draft 10 (for DFIS & Last Call),” JCTVC-J1003_v34, Geneva, January 2013 is hereby incorporated by reference herein in its entirety. B. Bros, W-J. Han, J-R. Ohm, G.J. Sullivan, Wang, and T-. Wiegand, “High efficiency video coding (HEVC) text specification draft 10,” JCTVC-L1003, Geneva, January 2013 is hereby incorporated by reference herein in its entirety. Chen, et al., “SHVC Draft 3,” JCTVC-N1008, Vienna, August 2013, is hereby incorporated by reference herein in its entirety. Tech, et al., “MV-HEVC Draft Text 5,” JCT3V-E1004, Vienna, August 2013, is hereby incorporated by reference herein in its entirety.

Examples regarding picture timing SEI message semantics in accordance with the systems and methods disclosed herein are given as follows. In particular, additional detail regarding the semantics of the modified syntax elements are given as follows.

The syntax of the picture timing SEI message is dependent on the content of the sequence parameter set that is active for the coded picture associated with the picture timing SEI message. However, unless the picture timing SEI message of an Instantaneous Decoding Refresh (IDR) access unit is preceded by a buffering period SEI message within the same access unit, the activation of the associated sequence parameter set (and, for IDR pictures that are not the first picture in the bitstream, the determination that the coded picture is an IDR picture) does not occur until the decoding of the first coded slice Network Abstraction Layer (NAL) unit of the coded picture. Since the coded slice NAL unit of the coded picture follows the picture timing SEI message in NAL unit order, there may be cases in which it is necessary for a decoder to store the raw byte sequence payload (RESP) containing the picture timing SEI message until determining the parameters of the sequence parameter that will be active for the coded picture, and then perform the parsing of the picture timing SEI message.

As illustrated by the foregoing, the systems and methods disclosed herein provide syntax and semantics that modify a picture timing SE message bitstreams carrying sub-picture based parameters. In some configurations, the systems and methods disclosed herein may be applied to HEVC specifications.

For convenience, several definitions are given as follows, which may be applied to the systems and methods disclosed herein. A random access point may be any point in a stream of data (e.g., bitstream) where decoding of the bitstream does not require access to any point in a bitstream preceding the random access point to decode a current picture and all pictures subsequent to said current picture in output order.

A buffering period may be specified as a set of access units between two instances of the buffering period SEI message in decoding order. Supplemental Enhancement Information (SEI) may contain information that is not necessary to decode the samples of coded pictures from VCL NAL units. SEI messages may assist in procedures related to decoding, display or other purposes. Conforming decoders may not be required to process this information for output order conformance to HEVC specifications (Annex C of HEVC specifications (JCTVC-L1003) includes specifications for conformance, for example). Some SEI message information may be used to check bitstream conformance and for output timing decoder conformance.

A buffering period SEI message may be an SEI message related to buffering period. A picture timing SEI message may be an SEI message related to CPB removal timing. These messages may define syntax and semantics which define bitstream arrival timing and coded picture removal timing.

A Coded Picture Buffer (CPB) may be a first-in first-out buffer containing access units in decoding order specified in a hypothetical reference decoder (HRD). An access unit may be a set of Network Access Layer (NAL) units that are consecutive in decoding order and contain exactly one coded picture. In addition to the coded slice NAL units of the coded picture, the access unit may also contain other NAL units not containing slices of the coded picture. The decoding of an access unit always results in a decoded picture. A NAL unit may be a syntax structure containing an indication of the type of data to follow and bytes containing that data in the form of a raw byte sequence payload interspersed as necessary with emulation prevention bytes.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

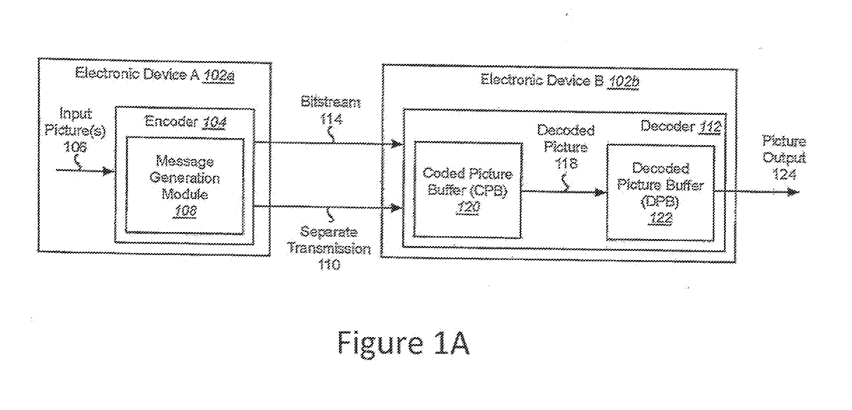

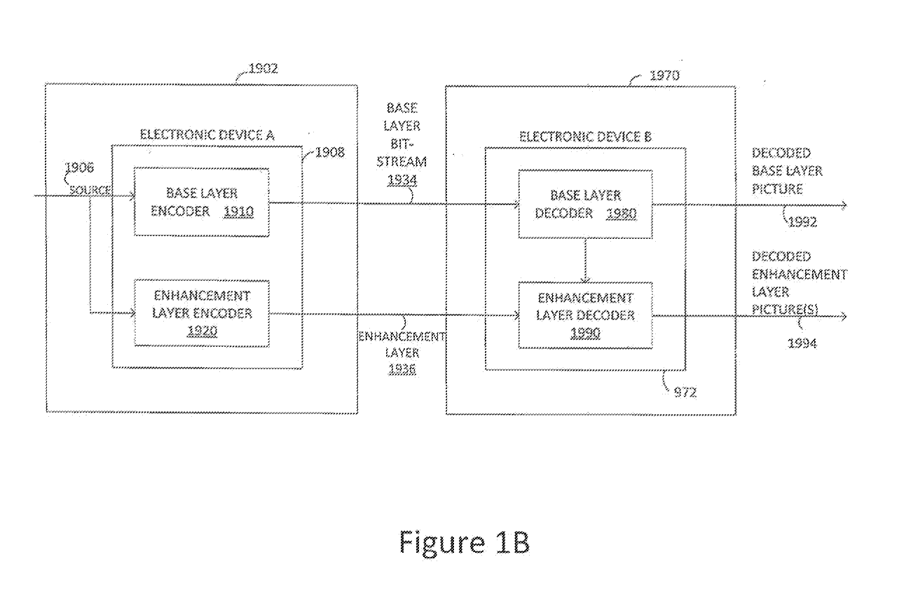

FIG. 1A is a block diagram illustrating an example of one or more electronic devices 102 in which systems and methods for sending a message and buffering a bitstream may be implemented. In this example, electronic device A 102a and electronic device B 102b are illustrated. However, it should be noted that one or more of the features and functionality described in relation to electronic device A 102a and electronic device B 102b may be combined into a single electronic device in some configurations.

Electronic device A 102a includes an encoder 104. The encoder 104 includes a message generation module 108. Each of the elements included within electronic device A 102a (e.g., the encoder 104 and the message generation module 108) may be implemented in hardware, software or a combination of both.

Electronic device A 102a may obtain one or more input pictures 106. In some configurations, the input picture(s) 106 may be captured on electronic device A 102a using an image sensor, may be retrieved from memory andor may be received from another electronic device.

The encoder 104 may encode the input picture(s) 106 to produce encoded data. For example, the encoder 104 may encode a series of input pictures 106 (e.g., video), In one configuration, the encoder 104 may be a HEVC encoder. The encoded data may be digital data (e.g., part of a bitstream 114). The encoder 104 may generate overhead signaling based on the input signal.

The message generation module 108 may generate one or more messages. For example, the message generation module 108 may generate one or more SEI messages or other messages, For a CPB that supports operation on a sub-picture level, the electronic device 102 may send sub-picture parameters, (e.g., CPB removal delay parameter). Specifically, the electronic device 102 (e.g., the encoder 104) may determine whether to include a common decoding unit CPB removal delay parameter in a picture timing SEI message.

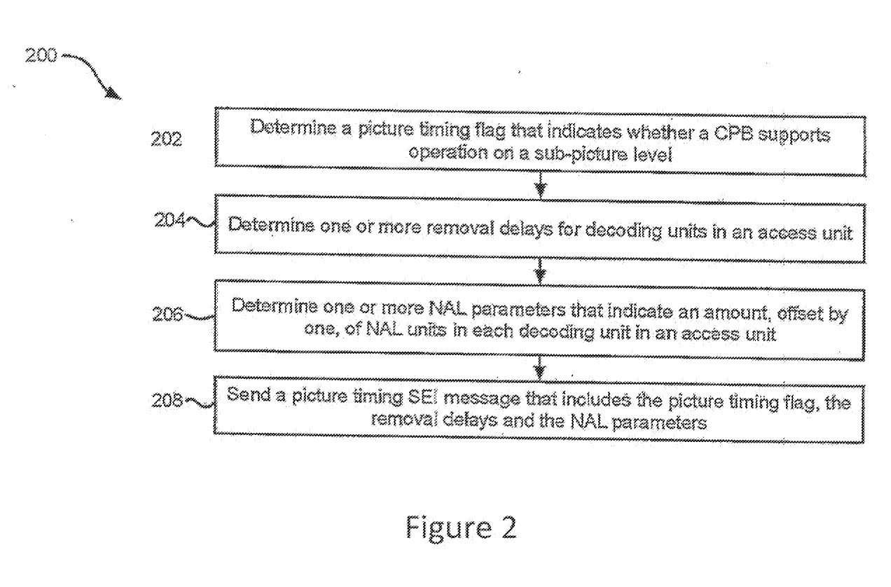

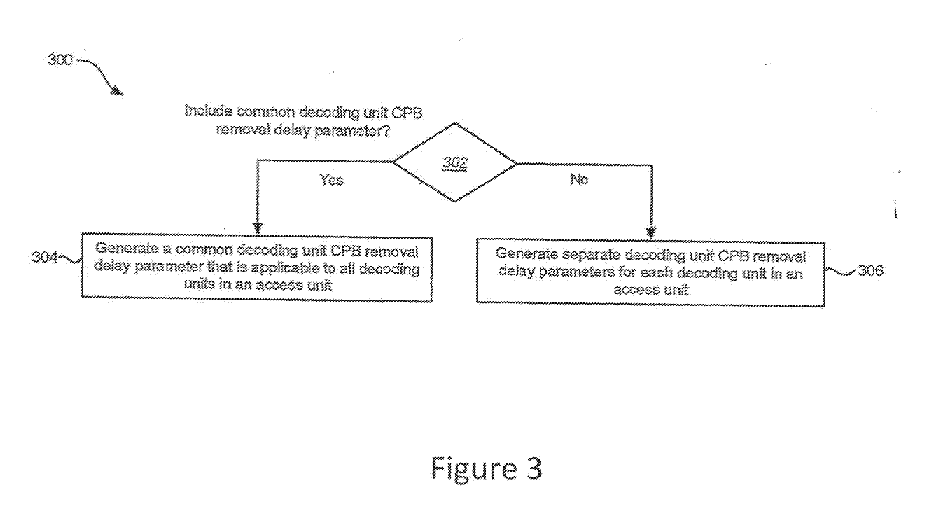

In contrast, when the common decoding unit CPB removal delay parameter is not to be included in the picture timing SEI message, the electronic device 102 may generate a separate decoding unit CPB removal delay for each decoding unit in the access unit with which the picture timing SEI message is associated. A message generation module 108 may perform one or more of the procedures described in connection with FIG. 2 and FIG. 3 below.

In some configurations, electronic device A 102a may send the message to electronic device B 102b as part of the bitstream 114. In some configurations electronic device A 102a may send the message to electronic device B 102b by a separate transmission 110, For example, the separate transmission may not be part of the bitstream 114. For instance, a picture timing SEI message or other message may be sent using some out-of-band mechanism. It should be noted that, in some configurations, the other message may include one or more of the features of a picture timing SEI message described above. Furthermore, the other message, in one or more aspects, may be utilized similarly to the SEI message described above.

The encoder 104 (and message generation module 108, for example) may produce a bitstream 114. The bitstream 114 may include encoded picture data based on the input picture(s) 106. In some configurations, the bitstream 114 may also include overhead data, such as a picture timing SEI message or other message, slice header(s), picture parameter set(s), etc. As additional input pictures 106 are encoded, the bitstream 114 may include one or more encoded pictures. For instance, the bitstream 114 may include one or more encoded pictures with corresponding overhead data (e,g a picture timing SEI message or other message).

The bitstream 114 may be provided to a decoder 112. In one example, the bitstream 114 may be transmitted to electronic device B 102b using a wired or wireless link. In some cases, this may be done over a network, such as the Internet or a Local Area Network (LAN). As illustrated in FIG. 1A, the decoder 112 may be implemented on electronic device B 102b separately from the encoder 104 on electronic device A 102a, However, it should be noted that the encoder 104 and decoder 112 may be implemented on the same electronic device in some configurations. In an implementation where the encoder 104 and decoder 112 are implemented on the same electronic device, for instance, the bitstream 114 may be provided over a bus to the decoder 112 or stored in memory for retrieval by the decoder 112.

The decoder 112 may be implemented in hardware, software or a combination of both. In one configuration, the decoder 112 may be a HEVC decoder. The decoder 112 may receive (e.g., obtain) the bitstream 114. The decoder 112 may generate one or more decoded pictures 118 based on the bitstream 114. The decoded picture(s) 118 may be displayed, played back, stored in memory andor transmitted to another device, etc.

The decoder 112 may include a CPB 120. The CPB 120 may temporarily store encoded pictures. The CPB 120 may use parameters found in a picture timing SEI message to determine when to remove data. When the CPB 120 supports operation on a sub-picture level, individual decoding units may be removed rather than entire access units at one time. The decoder 112 may include a Decoded Picture Buffer (DPB) 122. Each decoded picture is placed in the DPB 122 for being referenced by the decoding process as well as for output and cropping. A decoded picture is removed from the DPB at the later of the DPB output time or the time that it becomes no longer needed for inter-prediction reference.

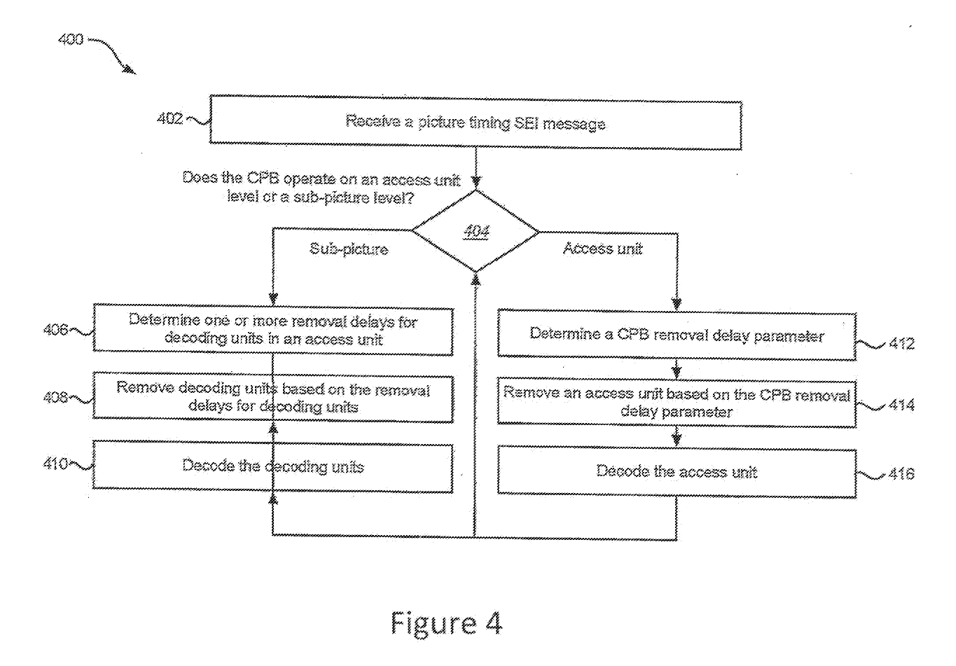

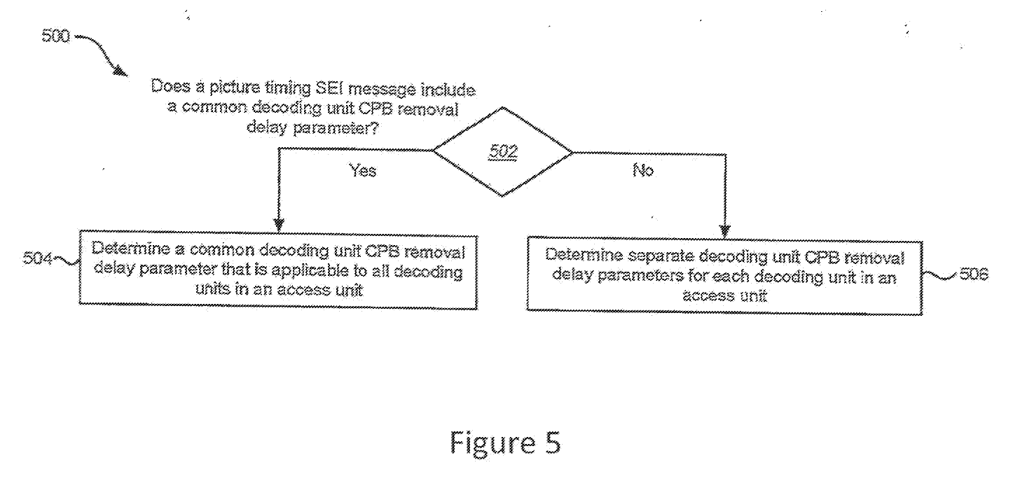

The decoder 112 may receive a message (e.g., picture timing SEI message or other message). The decoder 112 may also determine whether the received message includes a common decoding unit CPB removal delay parameter. This may include identifying a flag that is set when the common parameter is present in the picture timing SEI message. If the common parameter is present, the decoder 112 may determine the common decoding unit CPB removal delay parameter applicable to all decoding units in the access unit. If the common parameter is not present, the decoder 112 may determine a separate decoding unit CPB removal delay parameter for each decoding unit in the access unit. The decoder 112 may also remove decoding units from the CPB 120 using either the common decoding unit CPB removal delay parameter or the separate decoding unit CPB removal delay parameters. The CPB 120 may perform one or more of the procedures described in connection with FIG. 4 and FIG. 5 below.

The HRD described above may be one example of the decoder 112 illustrated in FIG. 1A. Thus, an electronic device 102 may operate in accordance with the HRD and CPB 120 and CPB 122 described above, in some configurations.

It should be noted that one or more of the elements or parts thereof included in the electronic device(s) 102 may be implemented in hardware. For example, one or more of these elements or parts thereof may be implemented as a chip, circuitry or hardware components, etc. It should also be noted that one or more of the functions or methods described herein may be implemented in andor performed using hardware. For example, one or more of the methods described herein may be implemented in andor realized using a chipset, an Application-Specific Integrated Circuit (ASIC), a Large.-Scale Integrated circuit (LSI) or integrated circuit, etc.

FIG. 1B is a block diagram illustrating another example of an encoder 1908 and a decoder 1972. In this example, electronic device A 1902 and electronic device B 1970 are illustrated. However, it should be noted that the features and functionality described in relation to electronic device A 1902 and electronic device B 1970 may be combined into a single electronic device in some configurations.

Electronic device A 1902 includes the encoder 1908. The encoder 1908 may include a base layer encoder 1910 and an enhancement layer encoder 1920. The video encoder 1908 is suitable for scalable video coding and multi-view video coding, as described later. The encoder 1908 may be implemented in hardware, software or a combination of both. In one configuration, the encoder 1908 may be a high-efficiency video coding (HEVC) coder, including scalable andor multi-view. Other coders may likewise be used. Electronic device A 1902 may obtain a source 1906. In some configurations, the source 1906 may be captured on electronic device A 1902 using an image sensor, retrieved from memory or received from another electronic device.

The encoder 1908 may code the source 1906 to produce a base layer bitstream 1934 and an enhancement layer bitstream 1936. For example, the encoder 1908 may code a series of pictures (e.g., video) in the source 1906. In particular, for scalable video encoding for SNR scalability also known as quality scalability the same source 1906 may be provided to the base layer and the enhancement layer encoder. In particular, for scalable video encoding for spatial scalability a downsarnpled source may be used for the base layer encoder. In particular, for multi-view encoding a different view source may be used for the base layer encoder and the enhancement layer encoder, The bitstreams 1934, 1936 may include coded picture data based on the source 1906. In some configurations, the bitstreams 1934, 1936 may also include overhead data, such as slice header information, picture parameter set (PPS) information, etc, As additional pictures in the source 1906 are coded, the bitstreams 1934, 1936 may include one or more coded pictures.

The bitstreams 1934, 1936 may be provided to the decoder 1972. The decoder 1972 may include a base layer decoder 1980 and an enhancement layer decoder 1990. The video decoder 1972 is suitable for scalable video decoding and multi-view video decoding. In one example, the bitstreams 1934, 1936 may be transmitted to electronic device B 1970 using a wired or wireless link. In some cases, this may be done over a network, such as the Internet or a Local Area Network (LAN). As illustrated in FIG. 1B, the decoder 1972 may be implemented on electronic device B 1970 separately from the encoder 1908 on electronic device A 1902. However, it should be noted that the encoder 1908 and decoder 1972 may be implemented on the same electronic device in some configurations. In an implementation where the encoder 1908 and decoder 1972 are implemented on the same electronic device, for instance, the bitstreams 1934, 1936 may be provided over a bus to the decoder 1972 or stored in memory for retrieval by the decoder 1972. The decoder 1972 may provide a decoded base layer 1992 and decoded enhancement layer picture(s) 1994 as output.

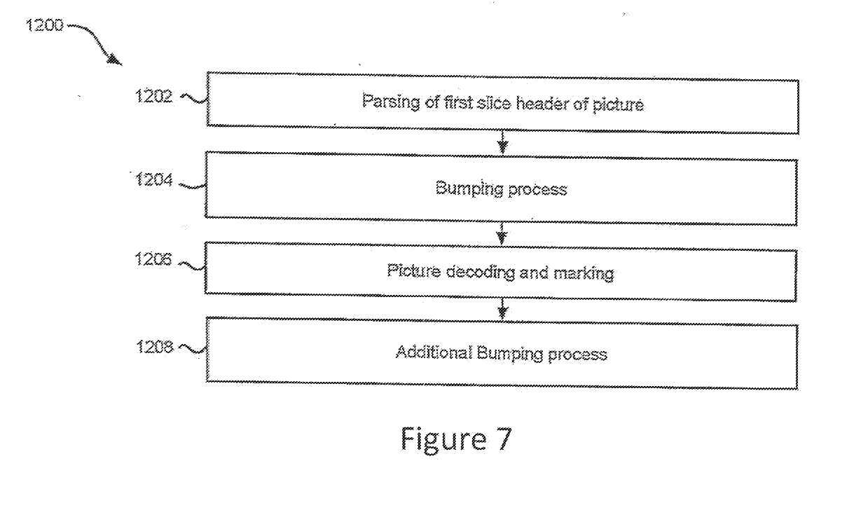

The decoder 1972 may be implemented in hardware, software or a combination of both. In one configuration, the decoder 1972 may be a high-efficiency video coding (HEVC) decoder, including scalable andor multi-view. Other decoders may likewise be used. The decoder 1972 may be similar to the decoder 1812 described later in connection with FIG. 7B. Also, the base layer encoder andor the enhancement layer encoder may each include a message generation module, such as that described in relation toFigure 1A. Also, the base layer decoder andor the enhancement layer decoder may include a coded picture buffer andor a decoded picture buffer, such as that described in relation to FIG. 1A. In addition, the electronic devices of FIG. 1B may operate in accordance with the functions of the electronic devices of FIG. 1A, as applicable.

FIG. 2 is a flow diagram illustrating one configuration of a method 200 for sending a message. The method 200 may be performed by an encoder 104 or one of its sub-parts (e.g., a message generation module 108). The encoder 104 may determine 202 a picture timing flag that indicates whether a CPB 120 supports operation on a sub-picture level. For example, when the picture timing flag is set to 1, the CPB 120 may operate on an access unit level or a sub-picture level. It should be noted that even when the picture timing flag is set to 1, the decision about whether to actually operate at the sub-picture level is left to the decoder 112 itSEIf.

The encoder 104 may also determine 204 one or more removal delays for decoding units in an access unit. For example, the encoder 104 may determine a single common decoding unit CPB removal delay parameter that is applicable to all decoding units in the access unit from the CPB 120. Alternatively, the encoder 104 may determine a separate decoding unit CPB removal delay for each decoding unit in the access unit.

The encoder 104 may also determine 206 one or more NAL parameters that indicate an amount, offset by one, of NAL units in each decoding unit in the access point. For example, the encoder 104 may determine a single common NAL parameter that is applicable to all decoding units in the access unit from the CPB 120. Alternatively, the encoder 104 may determine a separate decoding unit CPB removal delay for each decoding unit in the access unit.

The encoder 104 may also send 208 a picture timing SEI message that includes the picture timing flag, the removal delays and the NAL parameters. For example, the electronic device 102 may transmit the message via one or more of wireless transmission, wired transmission, device bus, network, etc. For instance, electronic device A 102a may transmit the message to electronic device B 102b. The message may be part of the bitstream 114, for example. In some configurations, electronic device A 102a may send 208 the message to electronic device B 102b in a separate transmission 110 (that is not part of the bitstream 114). For instance, the message may be sent using some out-of-band mechanism. In some case the information indicated in 204, 206 may be sent in a SEI message different than picture timing SEI message. In yet another case the information indicated in 204, 206 may be sent in a parameter set e.g. video parameter set andor sequence parameter set andor picture parameter set andor adaptation parameter set andor slice header.

FIG. 3 is a flow diagram illustrating one configuration of a method 300 for determining one or more removal delays for decoding units in an access unit. In other words, the method 300 illustrated in FIG. 3 may further illustrate step 204 in the method 200 illustrated in FIG. 2. The method 300 may be performed by an encoder 104. The encoder 104 may determine 302 whether to include a common decoding unit CPB removal delay parameter. This may include determining whether a common decoding unit CPB removal delay flag is set. An encoder 104 may send this common parameter in case the decoding units are removed from the CPB at regular interval. This may be the case, for example, when each decoding unit corresponds to certain number of rows of the picture or has some other regular structure.

For example, the common decoding unit CPB removal delay flag may be set to 1 when the common decoding unit CPB removal delay parameter is to be included in the picture timing SEI message and 0 when it is not to be included. If yes (e.g., flag is set to 1), the encoder 104 may determine 304 a common decoding unit CPB removal delay parameter (e.g., common_du_cpb_removal_delay) that is applicable to all decoding units in an access unit. If no (e.g., flag is set to 0), the encoder 104 may determine 306 separate decoding unit CPB removal delay parameters for each decoding unit in an access unit.

If a common decoding unit CPB removal delay parameter is present in a picture timing SEI message, it may specify an amount of sub-picture clock ticks to wait after removal from the CPB 120 of an immediately preceding decoding unit before removing from the CPB 120 a current decoding unit in the access unit associated with the picture timing SEI message.

For example, when a decoding unit is a first decoding unit in an access unit, the common decoding unit CPB 120 removal delay parameter may specify an amount of sub-picture clock ticks to wait after removal from the CPB 120 of a last decoding unit in an access unit associated with a most recent buffering period SEI message in a preceding access unit before removing from the CPB 120 the first decoding unit in the access unit associated with the picture timing SEI message.

When the decoding unit is a non-first decoding unit in an access unit, the common decoding unit CPB removal delay parameter may specify an amount of sub-picture clock ticks to wait after removal from the CPB 120 of a preceding decoding unit in the access unit associated with the picture timing SEI message before removing from the CPB a current decoding unit in the access unit associated with the picture timing SEI message.

In contrast, when a common decoding unit CPB removal delay parameter is not sent in a picture timing SEI message, separate decoding unit CPB removal delay parameters may be included in the picture timing SEI message for each decoding unit in an access unit. The decoding unit CPB removal delay parameters may specify an amount of sub-picture clock ticks to wait after removal from the CPB 120 of the last decoding unit before removing from the CPB 120 an i-th decoding unit in the access unit associated with the picture timing SEI message. The decoding unit CPB removal delay parameters may be calculated according to a remainder of a modulo 2^{(cpb}^{_{—}}^{removal}^{_{—}}^{delay}^{_{—}}^{length}^{_{—}}^{minus1+1)} counter where cpb_removal_delay_length_minus1+1 is a length of a common decoding unit CPB removal delay parameter.

FIG. 4 is a flow diagram illustrating one configuration of a method 400 for buffering a bitstream. The method 400 may be performed by a decoder 112 in an electronic device 102 (e.g., electronic device B 102b), which may receive 402 a message (e.g., a picture timing SEI message or other message). For example, the electronic device 102 may receive 402 the message via one or more of wireless transmission, wired transmission, device bus, network, etc. For instance, electronic device B 102b may receive 402 the message from electronic device A 102a. The message may be part of the bitstream 114, for example. In another example, electronic device B 102b may receive the message from electronic device A 102a in a separate transmission 110 (that is not part of the bitstream 114, for example). For instance, the picture timing SEI message may be received using some out-of-band mechanism. In some configurations, the message may include one or more of a picture timing flag, one or more removal delays for decoding units in an access unit and one or more NAL parameters. Thus, receiving 402 the message may include receiving one or more of a picture timing flag, one or more removal delays for decoding units in an access unit and one or more NAL parameters.

The decoder 112 may determine 404 whether a CPB 120 operates on an access unit level or a sub-picture level. For example, a decoder 112 may decide to operate on sub-picture basis if it wants to achieve low latency. Alternatively, the decision may be based on whether the decoder 112 has enough resources to support sub-picture based operation. If the CPB 120 operates on a sub-picture level, the decoder may determine 406 one or more removal delays for decoding units in an access unit.

The decoder 112 may also remove 408 decoding units based on the removal delays for the decoding units, i.e., using either a common parameter applicable to all decoding units in an access unit or separate parameters for every decoding unit. The decoder 112 may also decode 410 the decoding units.

If the CPB operates on an access unit level, the decoder 112 may determine 412 a CPB removal delay parameter. This may be included in the received picture timing SEI message. The decoder 112 may also remove 414 an access unit based on the CPB removal delay parameter and decode 416 the access unit. In other words, the decoder 112 may decode whole access units at a Lime, rather than decoding units within the access unit.

FIG. 5 is a flow diagram illustrating one configuration of a method 500 for determining one or more removal delays for decoding units in an access unit. In other words, the method 500 illustrated in FIG. 5 may further illustrate step 406 in the method 400 illustrated in FIG. 4. The method 500 may be performed by a decoder 112. The decoder 112 may determine 502 whether a received picture timing SEI message includes a common decoding unit CPB removal delay parameter. This may include determining whether a common decoding unit CPB removal delay flag is set, If yes, the decoder 112 may determine 504 a common decoding unit CPB removal delay parameter that is applicable to all decoding units in an access unit. If no, the decoder 112 may determine 506 separate decoding unit CPB removal delay parameters for each decoding unit in an access unit.

FIG. 7A is a block diagram illustrating one configuration of a decoder 712 on an electronic device 702. The decoder 712 may be included in an electronic device 702. For example, the decoder 712 may be a HEVC decoder. The decoder 712 and one or more of the elements illustrated as included in the decoder 712 may be implemented in hardware, software or a combination of both. The decoder 712 may receive a bitstream 714 (e.g., one or more encoded pictures and overhead data included in the bitstream 714) for decoding. In some configurations, the received bitstream 714 may include received overhead data, such as a message (e.g., picture timing SEI message or other message), slice header, PPS, etc. In some configurations, the decoder 712 may additionally receive a separate transmission 710. The separate transmission 710 may include a message (e.g., a picture timing SEI message or other message). For example, a picture timing SEI message or other message may be received in a separate transmission 710 instead of in the bitstream 714. However, it should be noted that the separate transmission 710 may be optional and may not be utilized in some configurations.

The decoder 712 includes a CPB 720. The CPB 720 may be configured similarly to the CPB 120 described in connection with FIG. 1 above. Additionally or alternatively, the decoder 712 may perform one or more of the procedures described in connection with FIG. 4 and FIG. 5. For example, the decoder 712 may receive a message (e.g., picture timing SEI message or other message) with sub-picture parameters and remove and decode decoding units in an access unit based on the sub-picture parameters. It should be noted that one or more access units may be included in the bitstream and may include one or more of encoded picture data and overhead data.

The Coded Picture Buffer (CPB) 720 may provide encoded picture data to an entropy decoding module 701. The encoded picture data may be entropy decoded by an entropy decoding module 701, thereby producing a motion information signal 703 and quantized, scaled andor transformed coefficients 705.

The motion information signal 703 may be combined with a portion of a reference frame signal 798 from a decoded picture buffer 709 at a motion compensation module 780, which may produce an inter-frame prediction signal 782. The quantized, descaled andor transformed coefficients 705 may be inverse quantized, scaled and inverse transformed by an inverse module 707, thereby producing a decoded residual signal 784. The decoded residual signal 784 may be added to a prediction signal 792 to produce a combined signal 786. The prediction signal 792 may be a signal SEIected from either the inter-frame prediction signal 782 produced by the motion compensation module 780 or an intra-frame prediction signal 790 produced by an intra-frame prediction module 788. In some configurations, this signal SEIection may be based on (e.g., controlled by) the bitstream 714.

The intra-frame prediction signal 790 may be predicted from previously decoded information from the combined signal 786 (in the current frame, for example). The combined signal 786 may also be filtered by a de-blocking filter 794. The resulting filtered signal 796 may be written to decoded picture buffer 709. The resulting filtered signal 796 may include a decoded picture. The decoded picture buffer 709 may provide a decoded picture which may be outputted 718. In some cases 709 may be a considered as frame memory.

FIG. 7B is a block diagram illustrating one configuration of a video decoder 1812 on an electronic device 1802. The video decoder 1812 may include an enhancement layer decoder 1815 and a base layer decoder 1813. The video decoder 812 may also include an interface 1889 and resolution upscaling 1870. The video decoder of FIG. 7B, for example, is suitable for scalable video coding and multi-view video encoded, as described herein.

The interface 1889 may receive an encoded video stream 1885. The encoded video stream 1885 may consist of base layer encoded video stream and enhancement layer encoded video stream. These two streams may be sent separately or together. The interface 1889 may provide some or all of the encoded video stream 1885 to an entropy decoding block 1886 in the base layer decoder 1813. The output of the entropy decoding block 1886 may be provided to a decoding prediction loop 1887. The output of the decoding prediction loop 1887 may be provided to a reference buffer 1888. The reference buffer may provide feedback to the decoding prediction loop 1887. The reference buffer 1888 may also output the decoded base layer video stream 1884.

The interface 1889 may also provide some or all of the encoded video stream 1885 to an entropy decoding block 1890 in the enhancement layer decoder 1815. The output of the entropy decoding block 1890 may be provided to an inverse quantization block 1891. The output of the inverse quantization block 1891 may be provided to an adder 1892. The adder 1892 may add the output of the inverse quantization block 1891 and the output of a prediction SEIection block 1895. The output of the adder 1892 may be provided to a deblocking block 1893. The output of the deblocking block 1893 may be provided to a reference buffer 1894. The reference buffer 1894 may output the decoded enhancement layer video stream 1882. The output of the reference buffer 1894 may also be provided to an intra predictor 1897. The enhancement layer decoder 1815 may include motion compensation 1896. The motion compensation 1896 may be performed after the resolution upscaling 1870. The prediction SEIection block 1895 may receive the output of the intra predictor 1897 and the output of the motion compensation 1896. Also, the decoder may include one or more coded picture buffers, as desired, such as together with the interface 1889.

FIG. 7 is a flow diagram illustrating one configuration of a method 1200 for operation of decoded picture buffer (OPB). The method 1200 may be performed by an encoder 104 or one of its sub-parts (e.g., a decoded picture buffer module 676). The method 1200 may be performed by a decoder 112 in an electronic device 102 (e.g., electronic device B 102b). Additionally or alternatively the method 1200 may be performed by a decoder 712 or one of its sub-parts (e.g., a decoded picture buffer module. 709). The decoder may parse first slice header of a picture 1202. The output and removal of pictures from IAPB before decoding of the current picture (but after parsing the slice header of the first slice of the current picture) happens instantaneously when first decoding unit of the access unit containing the current picture is removed from the CPB.
The decoding process for reference picture set (RPS) is invoked. Reference picture set is a set of reference pictures associated with a picture, consisting of all reference pictures that are prior to the associated picture in decoding order, that may be used for inter prediction of the associated picture or any picture following the associated picture in decoding order,
The bitstream of the video may include a syntax structure that is placed into logical data packets generally referred to as Network Abstraction Layer (NAL) units. Each NAL unit includes a NAL unit header, such as a two-byte NAL unit header (e.g., 16 bits), to identify the purpose of the associated data payload. For example, each coded slice (andor picture) may be coded in one or more slice (andor picture) NAL units. Other NAL units may be included for other categories of data, such as for example, supplemental enhancement information, coded slice of temporal sub-layer access (TSA) picture, coded slice of step-wise temporal sub-layer access (STSA) picture, coded slice a non-TSA, non-STSA trailing picture, coded slice of broken link access picture, coded slice of instantaneous decoded refresh picture, coded slice of clean random access picture, coded slice of decodable leading picture, coded slice of tagged for discard picture, video parameter set, sequence parameter set, picture parameter set, access unit delimiter, end of sequence, end of bitstream, filler data, andor sequence enhancement information message. Table (4) illustrates one example of NAL unit codes and NAL unit type classes. Other NAL unit types may be included, as desired. It should also be understood that the NAL unit type values for the NAL units shown in the Table (4) may be reshuffled and reassigned. Also additional NAL unit types may be added. Also some NAL unit types may be removed.

A random access decodable leading (RADL) access unit is an access unit in which the coded picture is a RADL picture.

A random access decodable leading (RADL) picture is a coded picture for which each VOL NAL unit has nal_unit_type equal to RADL_R or RADL_N.

A random access skipped leading (RASL) access unit is an access unit in which the coded picture is a RASL picture.

A random access skipped leading (RASL) picture is a coded picture for which each VOL NAL unit has nal_unit_type equal to RASL_R or RASL_N.

An intra random access point (IRAP) picture is a coded picture for which each video coding layer NAL unit has nal_unit_type in the range of BLA_ W_ LP to RSV_IRAP_VOL23, inclusive as shown in Table (4). An IRAP picture contains only Intra coded (I) slices. An instantaneous decoding refresh (IDR) picture is an IRAP picture for which each video coding layer NAL unit has nal_unit_type equal to IDR_W_RADL or IDR_N_LP as shown in Table (4). An instantaneous decoding referesh (IDR) picture contains only I slices, and may be the first picture in the bitstream in decoding order, or may appear later in the bitstream. Each IDR picture is the first picture of a CVS in decoding order. When an IDR picture for which each VCL NAL unit has nal_unit_type equal to IDR_W_RADL, it may have associated RADL pictures. When an IDR picture for which each VCL NAL unit has nal_unit_type equal to IDR_N_LP, it does not have any associated leading pictures. An IDR picture does not have associated RASL pictures. Each IDR picture is the first picture of a coded video sequence (CVS) in decoding order. A broken link access (BLA) picture is an IRAP picture for which each video coding layer NAL unit has nal_unit_type equal to BLA_W_LP, BLA_W_RADL, or BLA_N_LP as shown in Table (4). A BLA picture contains only I slices, and may be the first picture in the bitstream in decoding order, or may appear later in the bitstream. Each BLA picture begins a new coded video sequence, and has the same effect on the decoding process as an IDR picture. However, a BLA picture contains syntax elements that specify a non-empty reference picture set. When a BLA picture for which each VCL NAL unit has nal_unit_type equal to BLAW_LP, it may have associated RASL pictures, which are not output by the decoder and may not be decodable, as they may contain references to pictures that are not present in the bitstream. When a BLA picture for which each VCL NAL unit has nal_unit_type equal to BLA_W_LP, it may also have associated RADL pictures, which are specified to be decoded. When a BLA picture for which each VCL NAL unit has nal_unit_type equal to BLA_W_RADL, it does not have associated RASL pictures but may have associated RADL pictures. When a BLA picture for which each VCL NAL unit has nal_unit_type equal to BLAN_LP, it does not have any associated leading pictures.

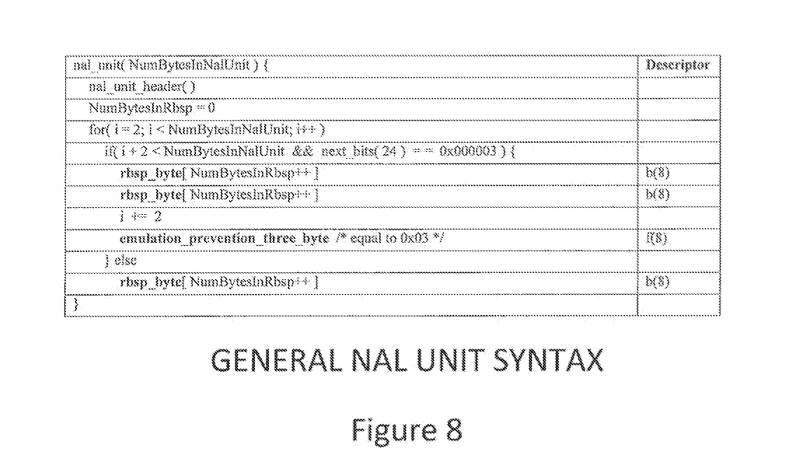

A clean random access (CRA) picture is an IRAP picture for which each VCL NAL unit has nal_unit_type equal to CRA_NUT. A CRA picture contains only I slices, and may be the first picture in the bitstream in decoding order, or may appear later in the bitstream.Referring to FIG. 8, a general NAL unit syntax structure is illustrated. The NAL unit header two byte syntax shown in Table (5) is included in the reference to nal_unit_header( ) of FIG. 8. The remainder of the NAL unit syntax primarily relates to the RBSP.

TABLE (4)

| | Name of | Content of NAL unit and RBSP | NAL unit |
|---|---|---|---|
| nal_unit_type | nal_unit_type | syntax structure | type class |
| 0 | TRAIL_N | Coded slice segment of a non-TSA, non- | VCL |
| 1 | TRAIL_R | STSA trailing picture | |
| | | slice_segment_layer_rbsp( ) | |
| 2 | TSA_N | Coded slice segment of a TSA picture | VCL |
| 3 | TSA_R | slice_segment_layer_rbsp( ) | |
| 4 | STSA_N | Coded slice segment of an STSA picture | VCL |
| 5 | STSA_R | slice_segment_layer_rbsp( ) | |
| 6 | RADL_N | Coded slice segment of a RADL picture | VCL |
| 7 | RADL_R | slice_segment_layer_rbsp( ) | |
| 8 | RASL_N | Coded slice segment of a RASL picture | VCL |
| 9 | RASL_R | slice_segment_layer_rbsp( ) | |
| 10 | RSV_VCL_N10 | Reserved non-IRAP sub-layer non- | VCL |
| 12 | RSV_VCL_N12 | reference VCL NAL unit types | |
| 14 | RSV_VCL_N14 | | |
| 11 | RSV_VCL_R11 | Reserved non-IRAP sub-layer reference | VCL |
| 13 | RSV_VCL_R13 | VCL NAL unit types | |
| 15 | RSV_VCL_R15 | | |
| 16 | BLA_W_LP | Coded slice segment of a BLA picture | VCL |
| 17 | BLA_W_RADL | slice_segment_layer_rbsp( ) | |
| 18 | BLA_N_LP | | |
| 19 | IDR_W_RADL | Coded slice segment of an IDR picture | VCL |
| 20 | IDR_N_LP | slice_segment_layer_rbsp( ) | |
| 21 | CRA_NUT | Coded slice segment of a CRA picture | VCL |
| | | slice_segment_layer_rbsp( ) | |
| 22 | RSV_IRAP_VCL22 | Reserved IRAP VCL NAL unit types | VCL |
| 23 | RSV_IRAP_VCL23 | | |
| 24 . . . 31 | RSV_VCL24 . . . | Reserved non-IRAP VCL NAL unit types | VCL |
| | RSV_VCL31 | | |
| 32 | VPS_NUT | Video parameter set | non-VCL |
| | | video_parameter_set_rbsp( ) | |
| 33 | SPS_NUT | Sequence parameter set | non-VCL |
| | | seq_parameter_set_rbsp( ) | |
| 34 | PPS_NUT | Picture parameter set | non-VCL |
| | | pic_parameter_set_rbsp( ) | |
| 35 | AUD_NUT | Access unit delimiter | non-VCL |
| | | access_unit_delimiter_rbsp( ) | |
| 36 | EOS_NUT | End of sequence | non-VCL |
| | | end_of_seq_rbsp( ) | |
| 37 | EOB_NUT | End of bitstream | non-VCL |
| | | end_of_bitstream_rbsp( ) | |
| 38 | FD_NUT | Filler data | non-VCL |
| | | filler_data_rbsp( ) | |
| 39 | PREFIX_SEI_NUT | Supplemental enhancement information | non-VCL |
| 40 | SUFFIX_SEI_NUT | sei_rbsp( ) | |
| 41 . . . 47 | RSV_NVCL41 . . . | Reserved | non-VCL |
| | RSV_NVCL47 | | |
| 48 . . . 63 | UNSPEC48 . . . | Unspecified | non-VCL |
| | UNSPEC63 | | |

Referring to Table (5), the NAL unit header syntax may include two bytes of data, namely, 16 bits. The first bit is a “forbidden_zero_bit” which is always set to zero at the start of a NAL unit. The next six bits is a “nal_unit_type” which specifies the type of raw byte sequence payloads (“RBSP”) data structure contained in the NAL unit as shown in Table (4). The next 6 bits is a “nuh_layer_id” which specify the identifier of the layer. In some cases these six bits may be specified as “nuh_reserved_zero_{—}6bits” instead. The nuh_reserved_zero_{—}6bits may be equal to 0 in the base specification of the standard. In a scalable video coding andor syntax extensions nuh_layer_id may specify that this particular NAL unit belongs to the layer identified by the value of these 6 bits. The next syntax element is “nuh_temporal_id_plus1”. The nuh_temporal_id_plus1 minus 1 may specify a temporal identifier for the NAL unit. The variable temporal identifier Temporalld may be specified as Temporalld=nuh_temporal_id_plus1−1. The temporal identifier Temporalld is used to identify a temporal sub-layer. The variable HighestTid identifies the highest temporal sub-layer to be decoded.

TABLE (5)

De-
scrip-
tor

nal_unit_header( ) {

| | |
|---|---|
| forbidden_zero_bit | f(1) |
| nal_unit_type | u(6) |
| nuh_layer_id | u(6) |
| nuh_temporal_id_plus1 | u(3) |

}

Table (6) shows an exemplary sequence parameter set (SPS) syntax structure.

chroma_format_idc specifies the chroma sampling relative to the luma sampling as specified in subclause 6.2. The value of chroma_format_idc shah be in the range of 0 to 3, inclusive.

separate_colour_plane_flag equal to 1 specifies that the three colour components of the 4:4:4 chroma format are coded separately. separate_colour_plane_flag equal to 0 specifies that the colour components are not coded separately. When separate_colour_plane_flag is not present, it is inferred to be equal to 0. When separate_colour_plane_flag is equal to 1, the coded picture consists of three separate components, each of which consists of coded samples of one colour plane (Y, Cb, or Cr) and uses the monochrome coding syntax. In this case, each colour plane is associated with a specific colour_plane_id value.

pic_width_in_luma_samples specifies the width of each decoded picture in units of luma samples. pic_width_in_luma_samples shall not be equal to 0.

pic_height_in_luma_samples specifies the height of each decoded picture in units of luma samples. pic_height_in_luma_samples shall not be equal to 0.

bit_depth_luma_minus8 specifies the bit depth of the samples of the luma array BitDepthY and the value of the luma quantization parameter range offset QpBdOffsetY as follows:

BitDepthY=8+bit_depth_luma_minus8

bit_depth_luma_minus8 shall be in the range of 0 to 6, inclusive. bit_depth_chroma_minus8 specifies the bit depth of the samples of the chroma arrays BitDepthC and the value of the chroma quantization parameter range offset QpBdOffsetC as follows:

BitDepthC=8+bit_depth_chroma_minus8

sps_max_sub_layers_minus1 plus 1 specifies the maximum number of temporal sub-layers that may be present in each CVS referring to the SPS. The value of sps_max_sub_layers_minus1 shall be in the range of 0 to 6, inclusive.

sps_sub_layer_ordering_info_present_flag flag equal to 1 specifies that sps_max_dec_pic_buffering_minus1[i], sps_max_num_reorder_pics[i], and sps_max_latency_increase_plus1[i] syntax elements are present for sps_max_sub_layers_minus1+1 sub-layers. sps_sub_layer_ordering_info_present_flag equal to 0 specifies that the values of sps_max_dec_pic_buffering_minus1[sps_max_sub_layers_minus1]. sps_max_num_reorder_pics[sps_max_sub_layers_minus1], and sps_max_latency_increase_plus1[sps_max_sub_layers_minus1] apply to all sub-layers.

sps_max_dec_pic_buffering_minus1[i] plus 1 specifies the maximum required size of the decoded picture buffer for the CVS in units of picture storage buffers when HighestTid is equal to i. The value of sps_max_dec_pic_buffering_minus1[i] shall be in the range of 0 to MaxDpbSize−1, inclusive where MaxDpbSize specifies the maximum decoded picture buffer size in units of picture storage buffers. When i is greater than 0, sps_max_dec_pic_buffering_minus1[i] shall be greater than or equal to sps_max_dec_pic_buffering_minus1[i−1]. When sps_max_dec_pic_buffering_minus1[i] is not present for i in the range of 0 to sps_max_sub_layers_minus1−1, inclusive, due to sps_sub_layerordering_info_present_flag being equal to 0, it is inferred to be equal to sps_max_dec_pic_buffering_minus1[sps_max_sub_layers_minus1].

sps_max_num_reorder_pics[i] indicates the maximum allowed number of pictures that can precede any picture in the CVS in decoding order and follow that picture in output order when HighestTid is equal to i. The value of sps_max_num_reorder_pics[i] shall be in the range of 0 to sps_max_dec_pic_buffering_minus1[i], inclusive. When i is greater than 0, sps_max_num_reorder_pics[i] shall be greater than or equal to sps_max_num_reorder_pics[i−1]. When sps_max_num_reorder_pics[i] is not present for i in the range of 0 to sps_max_sub_layers_minus1−1, inclusive, due to sps_sub_layer_ordering_info_present_flag being equal to 0, it is inferred to be equal to sps_max_num_reorder_pics[sps_max_sub_layers_minus1 ].

sps_max_latency_increase_plus1[i] not equal to 0 is used to compute the value of SpsMaxLatencyPictures[i], which specifies the maximum number of pictures that can precede any picture in the CVS in output order and follow that picture in decoding order when HighestTid is equal to i.

When sps_max_latency_increase_plus1[i] is not equal to 0, the value of SpsMaxLatencyPictures[i] is specified as follows:

SpsMaxLatencyPictures[i]=sps_max_num_reorder_pics[i]+sps_max_latency_increase_plus1[i]−1

When sps_max_latency_increase_plus1[i] is equal to 0, no corresponding limit is expressed.

The value of sps_max_latency_increase_plus1[i] shall be in the range of 0 to 2³²−2, inclusive. When sps_max_latency_increase_plus1[i] is not present for i in the range of 0 to sps_max_sub_layers_minus1−1, inclusive, due to sps_sub_layer_ordering_info_present_flag being equal to 0, it is inferred to be equal to sps_max latency_increase_plus1[sps_max_sub_layers_minus1].

sps_extension_flag equal to 1 specifies that sps_extension_type_flag[i] for i in the range of 0 to 7, inclusive are present in the SPS RBSP syntax structure. sps_extension_flag equal to 0 specifies that sps_extensionflag[i] for i in the range of 0 to 7, inclusive are not present in the SPS RBSP syntax structure.

sps_extension_type_flag[i] shall be equal to 0, for i equal to 0 and in the range of 2 to 6, inclusive, in bitstreams conforming to this version of this Specification. The value of 1 for sps_extension_type_flag[i], for i equal to 0 and in the range of 2 to 6, inclusive, is reserved for future use by ITU-T|ISO/IEC. sps_extension_type_flag[1] equal to 1 specifies that the sps_multilayer_extension syntax structure is present. sps_extension_type_flag[1] equal to 0 specifies that the sps_multilayer_extension syntax structure is not present. sps_extension_type_flag[7] equal to 0 specifies that no sps_extension_data_flag syntax elements are present in the SPS RBSP syntax structure. sps_extension_type_flag[7] shall be equal to 0 in bitstreams conforming to this version of this Specification. The value of 1 for sps_extension_type_flag[7] is reserved for future use by |TU-T|ISO/IEC. Decoders shall ignore all sps_extension_data_fiag syntax elements that follow the value 1 for sps_extension_type_flag[7] in an SPS NAL unit.

TABLE (6)

De-
scrip-
tor

seq_parameter_set_rbsp( ) {

...
if( nuh_layer_id > 0 ) {

...

} else {

| | |
|---|---|
| chroma_format_idc | ue(v) |
| if( chroma_format_idc = = 3 ) | |

| | |
|---|---|
| separate_colour_plane_flag | u(1) |

| | |
|---|---|
| pic_width_in_luma_samples | ue(v) |
| pic_height_in_luma_samples | ue(v) |

| | |
|---|---|
| } | |
| ... | |
| bit_depth_luma_minus8 | ue(v) |
| bit_depth_chroma_minus8 | ue(v) |
| ... | |
| for( i = ( sps_sub_layer_ordering_info_present_flag ? 0 : | |

sps_max_sub_layers_minus1 );

i <= sps_max_sub_layers_minus1; i++ ) {

| | |
|---|---|
| sps_max_dec_pic_buffering_minus1[ i ] | ue(v) |
| sps_max_num_reorder_pics[ i ] | ue(v) |
| sps_max_latency_increase_plus1[ i ] | ue(v) |

| | |
|---|---|
| } | |
| ... | |
| sps_extension_flag | u(1) |
| if( sps_extension_flag ) { | |

for ( i = 0; i < 8; i++ )

| | |
|---|---|
| sps_extension_type_flag[ i ] | u(1) |

if( sps_extension_type_flag[ 1 ] )

sps_multilayer_extension( )

if( sps_extension_type_flag[ 7 ] )

while( more_rbsp_data( ) )

| | |
|---|---|
| sps_extension_data_flag | u(1) |

}
rbsp_trailing_bits( )

}

Table (6A) shows an exemplary sequence parameter set multilayer extension syntax structure.

inter_view_mv_vert_constraint_flag equal to 1 specifies that vertical component of motion vectors used for inter-layer prediction are constrained in the CVS. When inter_view_mv_vert_constraint_flag is equal to 1, the vertical component of the motion vectors used for inter-layer prediction shah be equal to or less than 56 in units of lurna samples. When inter_view_mv_vert_constraint_flag is equal to 0, no constraint for of the vertical component of the motion vectors used for inter-layer prediction is signalled by this flag. When not present, the inter_view_mv_vert_constraint_flag is inferred to be equal to 0.

num_scaled_ref_layer_offsets specifies the number of sets of scaled reference layer offset parameters that are present in the SPS. The value of num_scaled_ref_layer_offsets shall be in the range of 0 to 62, inclusive.

The i-th scaled reference layer offset parameters specify the spatial correspondence of a picture referring to this SPS relative to an associated inter-layer picture with nuh_layer_id equal to scaled_ref_layer_id[i]. If the layer with nuh_layer_id equal to scaled_ref_layer_id[i] is a direct reference layer of the current picture, the associated inter-layer picture is the picture that is or could be included in the reference picture lists of the current picture. Otherwise, the associated inter-layer picture is any picture with nuh_layer_id equal to scaled_ref_layer_id[i] .

NOTE 1—When spatial scalability is in use, the associated inter-layer picture is a resampled picture of a direct reference layer.
NOTE 2—scaled_ref_layer_id[i] need not be among the direct reference layers for example when the spatial correspondence of an auxiliary picture to its associated primary picture is specified.

scaled_ref_layer_id[i] specifies the nuh_layer_id value of the associated inter-layer picture for which scaled_ref_layer_left_offset[i], scaled_ref_layer_top_offset[i], scaled_ref_layer_right_offset[i] and scaled_ref_layer_bottom_offset[i] are specified, The value of scaled_ref_layer_id[i] shall be less than the nuh_layer_id of any layer for which this SPS is the active SPS.

scaled_ref_layer_left_offset[scaled_ref_layer_id[i]] specifies the horizontal offset between the top-left luma sample of the associated inter-layer picture with nuh_layer_id equal to scaled_ref_layer_id[i] and the top-left luma sample of the current picture in units of two luma samples. When not present, the value of scaled_ref_layer_left_offset[scaled_ref_layer_id[i]] is inferred to be equal to 0.

scaled_ref_layer_top_offset[scaled_ref_layer_id[i]] specifies the vertical offset between the top-left luma sample of the associated inter-layer picture with nuh_layer_id equal to scaled_ref_layer_id[i] and the top-left luma sample of the current picture in units of two luma samples. When not present, the value of scaled_ref_layer_top_offset[scaled_ref_layer_id[i]] is inferred to be equal to 0.

scaled_ref_layer_right_offset[scaled_ref_layer_id[i]] specifies the horizontal offset between the bottom-right luma sample of the associated inter-layer picture with nuh_layer_id equal to scaled_ref_layer_id[i] and the bottom-right luma sample of the current picture in units of two luma samples. When not present, the value of scaled_ref_layer_right_offset[scaled_ref_layer_id[i]] is inferred to be equal to 0.

scaled_ref_layer_bottom_offset[scaled ref_layer_id[i]] specifies the vertical offset between the bottom-right luma sample of the associated inter-layer picture with nuh_layer_id equal to scaled_ref_layer_id[i] and the bottom-right luma sample of the current picture in units of two luma samples. When not present, the value of scaled_ref_layer_bottom_offset[scaled_ref_layer_id[i]] is inferred to be equal to 0.

TABLE (6A)

De-
scrip-
tor

sps_multilayer_extension( ) {

| | |
|---|---|
| inter_view_mv_vert_constraint_flag | u(1) |
| num_scaled_ref_layer_offsets | ue(v) |
| for( i = 0; i < num_scaled_ref_layer_offsets; i++) { | |

| | |
|---|---|
| scaled_ref_layer_id[ i ] | u(6) |
| scaled_ref_layer_left_offset[ | se(v) |
| scaled_ref_layer_id[ i ] ] | |
| scaled_ref_layer_top_offset[ | se(v) |
| scaled_ref_layer_id[ i ] ] | |
| scaled_ref_layer_right_offset[ | se(v) |
| scaled_ref_layer_id[ i ] ] | |
| scaled_ref_layer_bottom_offset[ | se(v) |
| scaled_ref_layer_id[ i ] ] | |

}

}

When the current picture is an IRAP picture and has r uh_layer_id equal to 0, the following applies:
The variable NoClrasOutputFlag is specified as follows:
   If the current picture is the first picture in the bitstream, NoClrasOutputFlag is set equal to 1.
   Otherwise, if the current picture is a BLA picture, NoClrasOutputFlag is set equal to 1.
   Otherwise, if some external means not specified in this Specification is available to set NoClrasOutputFlag, NoClrasOutputFlag is set by the external means.
   Otherwise, NoClrasOutputFlag is set equal to 0.
When NoClrasOutputFlag is equal to 1, the variable LayerinitialisedFlag[i] is set equal to 0 for all values of i from 0 to 63, inclusive, and the variable FirstPicinLayerDecodedFlag[i] is set equal to 0 for all values of i from 1 to 63, inclusive.

When the current picture is an IRAP picture, the following applies:
If the current picture with a particular value of nuh_layer_id is an IDR picture, a BLA picture, the first picture with that particular value of nuh_layer_id in the bitstream in the bitstream in decoding order, or the first picture with that particular value of nuh_layer_id that follows an end of sequence NAL unit in decoding order, a variable NoRaslOutputFlag is set equal to 1.
Otherwise, if some external means is available to set a variable HandleCraAsBlaFlag to a value for the current picture, the variable HandleCraAsBlaFlag is set equal to the value provided by that external means and the variable NoRaslOutputFlag is set equal to HandleCraAsBlaFlag.
Otherwise, the variable HandleCraAsBlaFlag is set equal to 0 and the variable NoRaslOutputFlag is set equal to 0.

When the current picture is an IRAP picture and one of the following conditions is true, LayerinitialisedFlag[i]nuh_layer_id is set equal to 1:
nuh_layer_id is equal to 0.
LayerinitialisedFlag[nuh_layer_id] is equal to 0 and LayerinitialisedFlag[refLayerId] is equal to 1 for all values of refLayerId equal to RefLayerId[nuh_layer_id][j], where j is in the range of 0 to NumDirectRefLayers[nuh_layer_id]−1, inclusive.

Within the decoding process for ending the decoding of a coded picture with nuh_layer_id greater than 0

FirstPicInLayerDecodedFlag[nuh_layer_id] is set equal 1.

If the current picture is an IRAP picture with NoRaslOutputFlag equal to 1 that is not picture 0, the following ordered steps are applied:

1. The variable NoOutputOfPriorPicsFlag is derived for the decoder under test as follows:
If the current picture is a CRA picture, NoOutputOfPriorPicsFlag is set equal to 1 (regardless of the value of no_output_of_prior_pics_flag).

Otherwise, if the value of pic_width_in_luma_samples, pic_height_in_luma_samples, or sps_max_dec_pic_buffering_minus1[HighestTid] derived from the active SPS is different from the value of pic_width_in_luma_samples, pic_height_in_luma_samples, or sps_max_dec_pic_buffering_minus1[HighestTid], respectively, derived from the SPS active for the preceding picture, NoOutputOfPriorPicsFlag may (but should not) be set to 1 by the decoder under test, regardless of the value of no_output_of_prior_pics_flag.
Otherwise, NoOutputOfPriorPicsFlag is set equal to no_output_of_prior_pics_flag.

2. The value of NoOutputOfPriorPicsFlag derived for the decoder under test is applied for the HRD as follows:
If NoOutputOfPriorPicsFlag is equal to 1, all picture storage buffers in the DPB are emptied without output of the pictures they contain, and the DPB fullness is set equal to 0.
Otherwise (NoOutputOfPriorPicsFlag is equal to 0), all picture storage buffers containing a picture that is marked as “not needed for output” and “unused for reference” are emptied (without output), and all non-empty picture storage buffers in the DPB are emptied by repeatedly invoking the “bumping” process 1204, and the DPB fullness is set equal to 0.

Otherwise (the current picture is not an IRAP picture with NoRaslOutputFlag equal to 1), all picture storage buffers containing a picture which are marked as “not needed for output” and “unused for reference” are emptied (without output). For each picture storage buffer that is emptied, the DPB fullness is decremented by one. When one or more of the following conditions are true, the “bumping” process 1204 is invoked repeatedly while further decrementing the DPB fullness by one for each additional picture storage buffer that is emptied, until none of the following conditions are true:

1. The number of pictures with that particular nuh_layer_id value in the DPB that are marked as “needed for output” is greater than sps_max_num_reorder_pics[HighestTid] from the active sequence parameter set (when that particular nuh_layer_id value is equal to 0) or from the active layer sequence parameter set for that particular nuh_layer_id value.

2. If sps_max_latency_increase_plus1[HighestTid] from the active sequence parameter set (when that particular nuh_layer_id value is equal to 0) or from the active layer sequence parameter set for that particular nuh_layer_id value is not equal to 0 and there is at least one picture with that particular nuh_layer_id value in the DPB that is marked as “needed for output” for which the associated variable PicLatencyCount is greater than or equal to SpsMaxLatencyPictures[HighestTid] for that particular nuh_layer_id value.

3. The number of pictures with that particular nuh_layer_id value in the DPB is greater than or equal to sps_max_dec_pic_buffering[HighestTid]+1 from the active sequence parameter set (when that particular nuh_layer_id value is equal to 0) or from the active layer sequence parameter set for that particular nuh_layer_id value.

Picture decoding process in the block 1206 (picture decoding and marking) happens instantaneously when the last decoding unit of access unit containing the current picture is removed from the CPB.

For each picture with nuh_layer_id value equal to current picture's nuh_layer_id value in the DPB that is marked as “needed for output”, the associated variable PicLatencyCount is set equal to PicLatencyCount+1.

The current picture is considered as decoded after the last decoding unit of the picture is decoded. The current decoded picture is stored in an empty picture storage buffer in the DPB, and the following applies:
If the current decoded picture has PicOutputFlag equal to 1, it is marked as “needed for output” and its associated variable PicLatencyCount is set equal to 0.
Otherwise (the current decoded picture has PicOutputFlag equal to 0), it is marked as “not needed for output”.

The current decoded picture is marked as “used for short-term reference”.

When one or more of the following conditions are true, the additional “bumping” process 1208 is invoked repeatedly until none of the following conditions are true:
The number of pictures with nuh_layer_id value equal to current picture's nuh_layer_id value in the DPB that are marked as “needed for output” is greater than sps_max_num_reorder_pics[HighestTid] from the active sequence parameter set (when the current picture's nuh_layer_id value is equal to 0) or from the active layer sequence parameter set for the current picture's nuh_layer_id value.
sps_max_latency_increase_plus1[HighestTid] from the active sequence parameter set (when the current picture's nuh_layer_id value is equal to 0) or from the active layer sequence parameter set for the current picture's nuh_layer_id value is not equal to 0 and there is at least one picture with that particular nuh_layer_id value in the DPB that is marked as “needed for output” for which the associated variable PicLatencyCount is greater than or equal to SpsMaxLatencyPictures[HighestTid] for that particular nuh_layer_id value.

The “bumping” process 1204 and additional bumping process 1208 are identical in terms of the steps and consists of the following ordered steps: The pictures that are first for output is SEIected as the ones having the smallest value of picture order count (PicOrderCntVal) of all pictures in the DPB marked as “needed for output”. A picture order count is a variable that is associated with each picture, uniquely identifies the associated picture among all pictures in the CVS, and, when the associated picture is to be output from the decoded picture buffer, indicates the position of the associated picture in output order relative to the output order positions of the other pictures in the same CVS that are to be output from the decoded picture buffer.
These pictures are cropped, using the conformance cropping window specified in the active sequence parameter set for the picture with nuh_layer_id equal to 0 or in the active layer sequence parameter set for a nuh_layer_id value equal to that of the picture, the cropped pictures are output in ascending order of nuh_layer_id, and the pictures are marked as “not needed for output”.
Each picture storage buffer that contains a picture marked as “unused for reference” and that included one of the pictures that was cropped and output is emptied.

Table(7) shows an exemplary video parameter set (VPS) sytax strucure

vps_video_parameter_set_id identifies the VPS for reference by other syntax elements.

vps_max_layers_minus1 shall be equal to 0 in bitstreams conforming to this version of this Specification. Other values for vps_max_layers_minus1 are reserved for future use by ITU-T|ISO/IEC. Although the value of vps_max_layers_minus1 is required to be equal to 0 in this version of this Specification, decoders shall allow other values of vps_max_layers_minus1 to appear in the syntax.

vps_max_sublayers_minus1 plus 1 specifies the maximum number of temporal sub-layers that may be present in the bitstream. The value of vps_max_sub_layers_minus1 shall be in the range of 0 to 6, inclusive.

vps_temporal_id_nesting_flag, when vps_max_sub_layers_minus1 is greater than 0, specifies whether inter prediction is additionally restricted for

CVSs referring to the VPS. When vps_max_sub_layers_minus1 is equal to 0, vps_temporal_id_nesting_flag shall be equal to 1.

vps_sub_layerordering_info_present_flag equal to 1 specifies that vps_max_dec_pic_buffering_minus1[i], vps_max_num_reorder_pics[i], and vps_max_latency_increase_plus1[i] are present for vps_max_sublayers_minus1+1 sub-layers. vps_sub_layer_ordering_info_present_flag equal to 0 specifies that the values of vps_max_dec_pic_buffering_minus1[vps_max_sub_layers_minus1], vps_max_num_reorder_pics[vps_max_sub_layers_minus1], and vps_max_latency_increase_plus1[vps_max_sub_layers_minus1] apply to all sub-layers.

vps_max_dec_pic_buffering_minus1[i] plus 1 specifies the maximum required size of the decoded picture buffer for the CVS in units of picture storage buffers when HighestTid is equal to i. The value of vps_max_dec_pic_buffering_minus1[i] shall be in the range of 0 to MaxDpbSize−1 (as specified in subclause A.4), inclusive. When i is greater than 0, vps_max_dec_pic_buffering_minus1[i] shall be greater than or equal to vps_max_dec_pic_buffering_minus1[i−1]. When vps_max_dec_pic_buffering_minus1[i] is not present for i in the range of 0 to vps_max_sub_layers_minus1−1, inclusive, due to vps_sub_layer_ordering_info_present_flag being equal to 0, it is inferred to be equal to vps_max_dec_pic_buffering_minus1[vps_max_sub_layers_minus1].

vps_max_num_reorder_pics[i] indicates the maximum allowed number of pictures that can precede any picture in the CVS in decoding order and follow that picture in output order when HighestTid is equal to i. The value of vps_max_num_reorder_pics[i] shall be in the range of 0 to vps_max_dec_pic_buffering_minus1[i], inclusive. When i is greater than 0, vps_max_num_reorder_pics[i] shall be greater than or equal to vps_max_num_reorder_pics[i−1], When vps_max_num_reorder_pics[i] is not present for i in the range of 0 to vps_max_sub_layers_minus1−1, inclusive, due to vps_sub_layer_ordering_info_present_flag being equal to 0, it is inferred to be equal to vps_max_num_reorder_pics[vps_max_sub_layers_minus1 ].

vps_max_latency_increase_plus1[i] not equal to 0 is used to compute the value of VpsMaxLatencyPictures[i], which specifies the maximum number of pictures that can precede any picture in the CVS in output order and follow that picture in decoding order when HighestTid is equal to i. When vps_max_latency_increase_plus1[i] is not equal to 0, the value of VpsMaxLatencyPictures[i] is specified as follows:

VpsMaxLatencyPictures[i]=vps_max_num_reorder_pics[i]+vps_max_latency_increase_plus1[i]−1

When vps_max_latency_increase_plus1[i] is equal to 0, no corresponding limit is expressed.
The value of vps_max_latency_increase_plus1[i] shall be in the range of 0 to 2³²−2, inclusive. When vps_max_latency_increase_plus1[i] is not present for i in the range of 0 to vps_max_sub_layers_minus1−1, inclusive, due to vps_sub_layer_ordering_info_present_flag being equal to 0, it is inferred to be equal to vps_max_latency_increase_plus1[vps_max_sub_layers_minus1].

vps_max_layer_id specifies the maximum allowed value of nuh_layer_id of all NAL units in the CVS.

vps_num_layer_sets_minus1 plus 1 specifies the number of layer sets that are specified by the VPS. In bitstreams conforming to this version of this Specification, the value of vps_num_layer_sets_minus1 shall be equal to 0. Although the value of vps_num_layer_sets_minus1 is required to be equal to 0 in this version of this Specification, decoders shall allow other values of vps_num_layer_sets_minus1 in the range of 0 to 1023, inclusive, to appear in the syntax.

layer_id_included _fiag[i][j] equal to 1 specifies that the value of nuh_layer_id equal to j is included in the layer identifier list layerSetLayerIdList[i]. layer_id_included_flag[i][j] equal to 0 specifies that the value of nuh_layer_id equal to j is not included in the layer identifier list layerSetLayerIdList[i].

The value of numLayersInIdList[0] is set equal to 1 and the value of layerSetLayerIdList[0][0] is set equal to 0.
For each value of i in the range of 1 to vps_num_layer_sets_minus1, inclusive, the variable numLayersInIdList[i] and the layer identifier list layerSetLayerIdList[i] are derived as follows:
n=0
for(m=0; m<=vps_max_layer_id: m++)

if(layer_id_included_flag[i][m]) (7 3)
layerSetLayerIdList[i][n++]=m
   numLayersInIdList[i]=n
   For each value of i in the range of 1 to vps_num_layer_sets_minus1, inclusive, numLayersinidList[i]shall be in the range of 1 to vps_max_layers_minus1+1, inclusive.
   When numLayersInIdList[i] is equal to numLayersIniciList[iB] for any iA and iB in the range of 0 to vps_num_layer_sets_minus1, inclusive, with iA not equal to iB, the value of layerSetLayerIdList[iA][n] shall not be equal to layerSetLayerIdList[iB][n] for at least one value of n in the range of 0 to numLayersinidList[iA], inclusive.
   A layer set is identified by the associated layer identifier list. The i-th layer set specified by the VPS is associated with the layer identifier list layerSetLayerIdList[i], for i in the range of 0 to vps_num_layer_sets_minus1, inclusive.
   A layer set consists of all operation points that are associated with the same layer identifier list.
   Each operation point is identified by the associated layer identifier list, denoted as OpLayeridList, which consists of the list of nuh_layer_id values of all NAL units included in the operation point, in increasing order of nuh_layer_id values, and a variable OpTid, which is equal to the highest Te.mporalld of all NAL units included in the operation point. The bitstream subset associated with the operation point identified by OpLayerIdList and OpTid is the output of the sub-bitstream extraction process as specified in clause 10 with the bitstream, the target highest TemporalId equal to OpTid, and the target layer identifier list equal to OpLayerIdList as inputs. The OpLayerIdList and OpTid that identify an operation point are also referred to as the OpLayerIdList and OpTid associated with the operation point, respectively.

TABLE (7)

De-
scrip-
tor

video_parameter_set_rbsp( ) {

| | |
|---|---|
| vps_video_parameter_set_id | u(4) |
| ... | |
| vps_max_layers_minus1 | u(6) |
| vps_max_sub_layers_minus1 | u(3) |
| vps_temporal_id_nesting_flag | u(1) |
| ... | |
| vps_sub_layer_ordering_info_present_flag | u(1) |
| for( i = ( vps_sub_layer_ordering_info_present_flag ? 0 : | |

vps_max_sub_layers_minus1 );

i <= vps_max_sub_layers_minus1; i++ ) {

| | |
|---|---|
| vps_max_dec_pic_buffering_minus1[ i ] | ue(v) |
| vps_max_num_reorder_pics[ i ] | ue(v) |
| vps_max_latency_increase_plus1[ i ] | ue(v) |

| | |
|---|---|
| } | |
| vps_max_layer_id | u(6) |
| vps_num_layer_sets_minus1 | ue(v) |
| for( i = 1; i <= vps_num_layer_sets_minus1; i++ ) | |

for( j = 0; j <= vps_max_layer_id; j++ )

| | |
|---|---|
| layer_id_included_flag[ i ][ j ] | u(1) |

...

}

Table(8) shows an exemplary video parameter set (VPS) extension sytax strucure

splitting_flag equal to 1 indicates that the dimension_id[i][j] syntax elements are not present and that the binary representation of the nuh_layer_id value in the NAL unit header are split into NumScalabilityTypes segments with lengths, in bits, according to the values of dimension_id_len_minus1[j] and that the values of dimension_id[LayeridxInVps[nuh_layer_id]][j] are inferred from the NumScalabilityTypes segments. splitting_flag equal to 0 indicates that the syntax elements dimension_id[i][j] are present.

NOTE—When splitting_flag is equal to 1, scalable identifiers can be derived from the nuh_layer_id syntax element in the NAL unit header by a bit masked copy. The respective bit mask for the i-th scalable dimension is defined by the value of the dimension_id_len_minus1[i] syntax element and dimBitOffset[i] as specified in the semantics of dimension_id_len_minus1[j].

scalability_mask_flat[i] equal to 1 indicates that dimension_id syntax elements corresponding to the i-th scalability dimension in Table F 1 are present. scalability_mask_flag[i] equal to 0 indicates that dimension_id syntax elements corresponding to the i-th scalability dimension are not present.

TABLE F 1
Mapping of ScalabiltyId to scalability dimensions

| scalability mask index | Scalability dimension | ScalabilityId mapping |
|---|---|---|
| 0 | Reserved | |
| 1 | Multiview | View Order Index |
| 2 | spatial/SNR scalability | DependencyId |
| 3 | Auxiliary | AuxId |
| 4-15 | Reserved | |

NOTE—It is anticipatedthat in future 3D extensions of this Specification, scalability mask index 0 will be used to indicate depth maps, It is anticipated that in future scalability extensions of this Specification, scalability mask index 2 will be used to indicate spatial/SNR scalability.

dimension_id_len_minus1[j] plus 1 specifies the length, in bits, of the dimension_id[i][j] syntax element.

When splitting flag is equal to 1, the following applies:
The variable dimBitOffset[0] is set equal to 0 and for j in the range of 1 to NumScalabilityTypes−1, inclusive, dimBitOffset[j] is derived as follows:

$$dimBitOffset [ j ] = {\sum }_{dimJdx = 0}^{j - 1} ( dimension\_id \_len \_minus1 [ dimIdx ] + 1 )$$

The value of dimension_id_len_minus1[NumScalabilityTypes−1] is inferred to be equal to 5—dimBitOffset[NumScalabilityTypes−1].
The value of dimBitOffset[NumScalabilityTypes] is set equal to 6.
   It is a requirement of bitstream conformance that when NumScalabilityTypes is greater than 0, dimBitOffset[NumScalabilityTypes−1] shall be less than 6.

vps_nuh_layer_id_present_flag equal to 1 specifies that layer_id_in_nuh[i] for i from 0 to MaxLayersMinus1, inclusive, are present. vps_nuh_layer_id_present_flag equal to 0 specifies that layer_id_in_nuh[i] for i from 0 to MaxLayersMinus1, inclusive, are not present.

layer_id_in_nuh[i] specifies the value of the nuh_layer_id syntax element in VCL NAL units of the i-th layer. For i in the range of 0 to MaxLayersMinus1, inclusive, when layer_id_in_nuh[i] is not present, the value is inferred to be equal to i.

When i is greater than 0, layer_id_in_nuh[i] shall be greater than layer_id_in_nuh[i−1].
For i from 0 to MaxLayersMinus1, inclusive, the variable LayerIdxInVps[layer_id_in_nuh[i]] is set equal to i.

dimension_id[i][j] specifies the identifier of the j-th present scalability dimension type of the i-th layer. The number of bits used for the representation of dimension_id[i][j] is dimension_id_len_minus1[j]+1 bits. Depending on splitting flag, the following applies:
if splitting_flag is equal to 1, for i from 0 to MaxLayersMinus1, inclusive, and j from 0 to NumScalabilityTypes−1, inclusive, dimension_id[i][j] is inferred to be equal to ((layer_id_in_nuh[i] & ((1<<dimBitOffSet[j+1])−1))>>dimBitOffset[j]),
Otherwise (splitting_flag is equal to 0), for j from 0 to NumScalabilityTypes−1, inclusive, dimension _id[0][j] is inferred to be equal to 0.
   The variable ScalabilityId[i][smldx] specifying the identifier of the smldx-th scalability dimension type of the i-th layer, the variable ViewOrderIdx[layer_id_in_nuh[i]] specifying the view order index of the i-th layer, DependencyId[layer_id_in_nuh[i]] specifying the spatial/SNR scalability identifier of the i-th layer, and the variable ViewScalExtLayerFlag[layer_id_in_nuh[i]] specifying whether the i-th layer is a view scalability extension layer are derived as follows:

```
NumViews = 1
for( i = 0; i <= MaxLayersMinus1; i++ ) {
  IId = layer_id_in_nuh[ i ]
  for( smIdx= 0, j = 0; smIdx < 16; smIdx++ )
    if( scalability_mask_flag[ smIdx ] )
      ScalabilityId[ i ][ smIdx ] = dimension_id[ i ][j++ ]
  ViewOrderIdx[ IId ] = ScalabilityId[ i ][ 1 ]
  DependencyId [ IId ] = ScalabilityId[ i ][ 2]
  if( i > 0 && ( ViewOrderIdx[ IId ] != ScalabilityId[ i − 1][ 1 ] ) )
    NumViews++
  ViewScalExtLayerFlag[ IId ] = ( ViewOrderIdx[ IId ] > 0)
  AuxId[ IId ] = ScalabilityId[ i ][ 3 ]
}
```

Auxid[IId] equal to 0 specifies the layer with nuh_layer_id equal to lid does not contain auxiliary pictures. Auxid[IId] greater than 0 specifies the type of auxiliary pictures in layer with nuh_layer_id equal to IId as specified in Table F 2.

A primary picture is a picture with a nuh_layer_id value such that AuxId[nuh_layer_id] is equal to 0.

TABLE F 2
Mapping of AuxId to the type of auxiliary pictures

| AuxId | Name of AuxId | Type of auxiliary pictures |
|---|---|---|
| 1 | AUX_ALPHA | Alpha plane |
| 2 | AUX_DEPTH | Depth picture |
| 4-127 | | Reserved |
| 128-143 | | Unspecified |
| 144-255 | | Reserved |

NOTE—The interpretation of auxiliary pictures associated with Auxid in the range of 128 to 143, inclusive, is specified through means other than the Auxid value.
Auxid[IId] shall be in the range of 0 to 2, inclusive, or 128 to 143, inclusive, for bitstreams conforming to this version of this Specification. Although the value of Auxid[IId] shall be in the range of 0 to 2, inclusive, or 128 to 143, inclusive, in this version of this Specification, decoders shall allow values of Auxid[IId] in the range of 0 to 255, inclusive.
The Table F 2 is just an example regarding mapping Auxid to the auxiliary pictures. For example an alternate mapping may be as shown in Table F 2A below.

TABLE F-2A
Mapping of AuxId to the type of auxiliary pictures

| AuxId | Name of AuxId | Type of auxiliary pictures |
|---|---|---|
| 1 | AUX_ALPHA | Alpha plane |
| 3-127 | | Reserved |
| 128-143 | | Unspecified |
| 144-255 | | Reserved |

For an auxiliary picture with nuh_layer_id equal to nuhLayerIdA, an associated primary picture, if any, is the picture in the same access unit having AuxId[nuhLayerIdB] equal to 0 such that Scalabilityld[LayerIdxInVps[nuhLayerIdA]][j] is equal to ScalabilityId[LayerIdxInVps[nuhLayerIdB]][j] for all values of j in the range of 0 to 2, inclusive, and 4 to 15, inclusive.
It is a requirement of bitstream conformance that there shall be an associated primary picture for each auxiliary picture with AuxId[nuh_layerid] equal to AUX_ALPHA.
NOTE—It is not required that each auxiliary picture of each auxiliary picture type has an associated primary picture. For example, a layer with AuxId[nuh_layer_id] equal to AUX_DEPTH may represent a viewpoint of a range sensing camera, while the layers containing primary pictures may represent conventional cameras.

direct_dependency_flag[i][j] equal to 0 specifies that the layer with index j is not a direct reference layer for the layer with index i.

direct_dependency_flag[i][i] equal to 1 specifies that the layer with index j may be a direct reference layer for the layer with index i. When direct_dependency_flag[i][j] is not present for i and j in the range of 0 to MaxLayersMinus1, it is inferred to be equal to 0.
The variables NumDirectRefLayers[i] and RefLayerId[i][j] are derived as follows:

```
for( i = 0; i <= MaxLayersMinus1; i++ ) {
  iNuhLId = layer_id_in_nuh[ i ]
  NumDirectRefLayers[ iNuhLId ] = 0
  for( j = 0; j < i; j++ )
    if( direct_dependency_flag[ i ][ j ] )
      RefLayerId[ iNuhLId ][ NumDirectRefLayers[ iNuhLId ]++ ] =
layer_id_in_nuh[ j ]}
```

The variable NumRefLayers[i] is derived as follows:
NumRefLayers[i] is first initialized to 0 for all values of i in the range of 0 and 63, inclusive.
For each layer with nuh_layer_id equal to currLayerId, and for all values of j in the range of 0 to 63, inclusive, the variable recursiveRefLayerFlag[currLayerId][j] is first initialized to 0. The variable recursiveRefLayerFlag[currLayerId][j] is then modified using the function setRefLayerFlags( currLayerId), specified as follows:

```
for( j = 0; j < NumDirectRefLayers[ currLayerId ]; j++ ) {
    refLayerId = RefLayerId[ currLayerId ][ j ]
    recursiveRefLayerFlag[ currLayerId ][ refLayerId ] = 1
    for( k = 0; k <= 63; k++ )
      recursiveRefLayerFlag[ currLayerId ][ k ] =
        recursiveRefLayerFlag[currLayerId ][ k ] |
recursiveRefLayerFlag[ refLayerId ][ k ]
}
— NumRefLayers [ i ] is modified as follows:
for( i = 0; i <= vps_max_layers_minus1; i++ ) {
    iNuhLId = layer_id_in_nuh[ i ]
    setRefLayerFlags( iNuhLId )
    for( j = 0; j <= 63; j++ )
      NumRefLayers[ iNuhLId ] += recursiveRefLayerFlag[ iNuhLId ][ j ]
}
```

It is a requirement of bitstream conformance that AuxId[RefLayerId[nuhLayerIdA][j]] for any values of nuhLayerIdA and j shall be equal to AuxId[nuhLayerIdA], when AuxId[nuhLayerIdA] is in the range of 0 to 2, inclusive.
NOTE—In other words, no prediction takes place between layers with a different value of AuxId, when AuxId is in the range of 0 to 2, inclusive.

cross_layer_phase_alignment_flag equal to 1 specifies that the locations of the luma sample grids of all layers are aligned at the center sample position of the pictures. cross_layer_phase_alignment_flag equal to 0 specifies that the locations of the luma sample grids of all layers are aligned at the top-left sample position of the pictures

TABLE (8)

De-
scrip-
tor

vps_extension( ) {
...

| | |
|---|---|
| splitting_flag | u(1) |
| for( i = 0, NumScalabilityTypes = 0; i < 16; i++ ) { | |

| | |
|---|---|
| scalability_mask_flag[ i ] | u(1) |
| NumScalabilityTypes += scalability_mask_flag[ i ] | |

}
for( j = 0; j < ( NumScalabilityTypes − splitting_flag ); j++ )

| | |
|---|---|
| dimension_id_len_minus1[ j ] | u(3) |

| | |
|---|---|
| vps_nuh_layer_id_present_flag | u(1) |
| for( i = 1; i <= MaxLayersMinus1; i++ ) { | |

if( vps_nuh_layer_id_present_flag )

| | |
|---|---|
| layer_id_in_nuh[ i ] | u(6) |

if( !splitting_flag )

for( j = 0; j < NumScalabilityTypes; j++ )

| | |
|---|---|
| dimension_id[ i ][ j ] | u(v) |

}
...

...

for( i = 1; i <= MaxLayersMinus1; i++ )

for( j = 0; j < i; j++ )

| | |
|---|---|
| direct_dependency_flag[ i ][ j ] | u(1) |

| | |
|---|---|
| cross_layer_phase_alignment_flag | u(1) |
| ... | |

}

Table (9) shows an exemplary picture parameter set (PPS) syntax structure

pps_pic_parametersetid identifies the PPS for reference by other syntax elements. The value of pps_pic_parameter_set_id shall be in the range of 0 to 63, inclusive.

num_extra_slice_header_bits equal to 0 specifies that no extra slice header bits are present in the slice header RESP for coded pictures referring to the PPS.

TABLE (9)

De-
scrip-
tor

pic_parameter_set_rbsp( ) {

| | |
|---|---|
| pps_pic_parameter_set_id | ue(v) |
| ... | |
| num_extra_slice_header_bits | u(3) |
| ... | |

}

Table (10) shows an exemplary slice segment header syntax structure

first_slice_segment_in_pic_flag equal to 1 specifies that the slice segment is the first slice segment of the picture in decoding order.

first_slice_segment_in_pic_flag equal to 0 specifies that the slice segment is not the first slice segment of the picture in decoding order.

no_putput_of_prior_pics_flag affects the output of previously-decoded pictures in the decoded picture buffer after the decoding of an IDR or a BLA picture that is not the first picture in the bitstream.

slice_pic_parameter_set_id specifies the value of pps_pic_parameterset for the PPS in use. The value of slice_pic_parameter_set_id shall be in the range of 0 to 63, inclusive.

dependent_slice_segment_flag equal to 1 specifies that the value of each slice segment header syntax element that is not present is inferred to be equal to the value of the corresponding slice segment header syntax element in the slice. header. When not present, the value of dependent_slice_segment_flag is inferred to be equal to 0.

slice_segment_address specifies the address of the first coding tree block in the slice segment, in coding tree block raster scan of a picture.

poc_reset_flag equal to 1 specifies that the derived picture order count for the current picture is equal to 0. poc_reset_flag equal to 0 specifies that the derived picture order count for the current picture may or may not be equal to 0. It is a requirement of bitstream conformance that when cross_layer_irap_aligned_flag is equal to 1, the value of poc_reset_flag shall be equal to 0. When not present, the value of poc_reset_fiag is inferred to be equal to 0.

discardable_flag equal to 1 specifies that the coded picture is not used as a reference picture for inter prediction and is not used as an inter-layer reference picture in the decoding process of subsequent pictures in decoding order. discardable_flag equal to 0 specifies that the coded picture may be used as a reference picture for inter prediction and may be used as an inter-layer reference picture in the decoding process of subsequent pictures in decoding order. When not present, the value of discardable_flag is inferred to be equal to 0.

slice_reserved_flag[i] has semantics and values that are reserved for future use by |TU-T| ISO/IEC. Decoders shall ignore the presence and value of slice_reserved_flag[i].

inter_layer_pred_enabled_flag equal to 1 specifies that inter-layer prediction may be used in decoding of the current picture.

inter_layer_pred_enabled_flag equal to 0 specifies that inter-layer prediction is not used in decoding of the current picture.

num_interlayerref pics_minus1 plus 1 specifies the number of pictures that may be used in decoding of the current picture for inter-layer prediction. The length of the num_inter_layer_ref_pics_minus1 syntax element is Ceil(Log2(NumDirectRefLayers[nuh_layer_]id)) bits. The value of num_interlayer_ref pics_minus1 shall be in the range of 0 to NumDirectRefLayers[nuh_layer_id]−1, inclusive.

The variable NumActiveRefLayerPics is derived as follows:
if(nuh_layer_id==0||NumDirectRefLayers[nuh_layer_id]==0)

NumActiveRefLayerPics=0

else if(all_ref_layers_active_flag)

NumActiveRefLayerPics=NumDirectRefLayers[nuh_layer_id]

else if(!interlayer_pred_enabled_flag)

NumActiveRefLayerPics=0

else if(max_one_active_ref_layer_flag||NumDirectRefLayers[nuh_layer_id]==1)

NumActiveRefLayerPics=1

else

NumActiveRefLayerPics=num_inter_layer_ref_pics_minus1+1

All slices of a coded picture shall have the same value of NumActiveRefLayerPics.

inter_layer_pred_layer_idc[i] specifies the variable, RefPicLayerId[i], representing the nuh_layer_id of the i-th picture that may be used by the current picture for inter-layer prediction. The length of the syntax element inter_layer_pred_layer_idc[i] is Ceil(Log2(NumDirectRefLayers[nuh_layer_id])) bits. The value of inter_layer_pred_layeridc[i] shall be in the range of 0 to NumDirectRefLayers[nuh_layer_id]−1, inclusive. When not present, the value of inter_layer_pred_layer_idc[i] is inferred to be equal to i.

When i is greater than 0, inter_layer_pred_layer_idc[i] shall be greater than inter_layer_pred_layer_idc[−1].
The variables RefPicLayerId[i] for all values of i in the range of 0 to NumActiveRefLayerPics−1, inclusive, are derived as follows:
for(i=0, j=0; i<NumActiveRefLayerPics; i++)

RefPicLayerId[i]=RefLayerId[nuh_layer_id][inter_layer_pred_layer_idc[i]]

All slices of a picture shall have the same value of inter_layer_pred_layer_idc[i] for each value of i in the range of 0 to NumActiveRefLayerPics−1, inclusive.
It is a requirement of bitstream conformance that for each value of i in the range of 0 to NumActiveRefLayerPics−1, inclusive, either of the following two conditions shall be true;

The value of max_tid_il_ref_pics_plus1[LayerIdxinVps[RefPicLayerId[i]]] is greater than Temporalld.
The values of max_tid_il_ref_pics_plus1[LayerIdxInVps[RefPicLayerId[i]]] and TemporalId are both equal to 0 and the picture in the current access unit with nuh_layer_id equal to RefPicLayerId[i] is an IRAP picture.

TABLE (10)

De-
scrip-
tor

slice_segment_header( ) {

| | |
|---|---|
| first_slice_segment_in_pic_flag | u(1) |
| if( nal_unit_type >= BLA_W_LP && nal_unit_type <= | |

RSV_IRAP_VCL23 )

| | |
|---|---|
| no_output_of_prior_pics_flag | u(1) |

| | |
|---|---|
| ... | ue(v) |
| if( !first_slice_segment_in_pic_flag ) { | |

if( dependent_slice_segments_enabled_flag )

| | |
|---|---|
| dependent_slice_segment_flag | u(1) |

| | |
|---|---|
| slice_segment_address | u(v) |

}
if( !dependent_slice_segment_flag ) {

i = 0
if( num_extra_slice_header_bits > i ) {

| | |
|---|---|
| i++ | |
| poc_reset_flag | u(1) |

}
if( num_extra_slice_header_bits > i ) {

| | |
|---|---|
| i++ | |
| discardable_flag | u(1) |

}
for( i = 1; i < num_extra_slice_header_bits; i++ )

| | |
|---|---|
| slice_reserved_flag[ i ] | u(1) |

...
if( nuh_layer_id > 0 && !
all_ref_layers_active_flag &&
NumDirectRefLayers[ nuh_layer_id ] > 0 ) {

| | |
|---|---|
| inter_layer_pred_enabled_flag | u(1) |
| if( inter_layer_pred_enabled_flag && | |

NumDirectRefLayers[ nuh_layer_id ] > 1) {

if( !max_one_active_ref_layer_flag )

| | |
|---|---|
| num_inter_layer_ref_pics_minus1 | u(v) |

if( NumActiveRefLayerPics !=

NumDirectRefLayers[ nuh_layer_id ] )

for( i = 0; i < NumActiveRefLayerPics;

i++)

| | |
|---|---|
| inter_layer_pred_layer_idc[ i ] | u(v) |

}

}
...

}
...

}

One existing technique for managing pictures within the DPB is to evaluate after decoding of slice header, whether pictures in the previous access unit for the current layer need to be maintained within the DPB. If a picture in the previous access unit of the current layer does not have to be maintained in the DPB then the picture storage corresponding to that picture is emptied. Whether a picture is to be maintained within the DPB depends on the how the picture is marked.

Another existing technique for managing storage within the DPB is to Select within the “Bumping” process pictures that are first for output. These pictures are cropped, using the conformance cropping window specified in the active SPS for the picture with nuh_layer_id equal to 0 or in the active layer SPS for a non-zero nuh_layer_id value equal to that of the picture, the cropped pictures are output in ascending order of nuh_layer_id, and the pictures are marked as “not needed for output”, Each picture storage buffer that contains a picture marked as “unused for reference” and that was one of the pictures cropped and output is emptied.

During the upsampling process (also referred to as the resampling process) the following variables are defined:

A decoded reference layer picture rlPic
A variable aid specifies the layer id of reference layer picture

The variables PicWidthInSamplesY and PicHeightinSamplesY are set equal to pic_width_in_luma_samples and pic_height_in_luma_samples, respectively. The variables RefLayerPicWidthinSamplesY and RelLayerPicHeightinSamplesY are set equal to the width and height of the decoded reference layer picture rlPic in units of lama samples, respectively. The variables RefLaye.rBitDepthY and RefLayerBitDepthC are set equal to BitDepthY and BitDepthC of the decoded reference layer picture rlPic, respectively.

Note—The variables SubWidthC, SubHeightC corresponds to the current layer.
The variables PicWidthInSamplesC, PicHeightinSamplesC,
RefLayerPicWidthInSamplesC, and RefLayerPicHeightinSamplesC are derived as follows:

### PicWidthInSamplesC=PicWidthInSamplesY/SubWidthC

### PicHeightInSamplesC=PicHeightInSamplesY/SubHeightC

### RefLayerPicWidthInSamplesC=RefLayerPicWidthlnSamplesY/SubWidthC

### RefLayerPicHeightlnSamplesC=RefLayerPicHeightinSamplesY/SubHeightC

The variable currLayerId is set equal to nuh_layer_id of the current picture.
The variables Scaled RefLayerLeftOffset, ScaledRefLayerTopOffset,
Scaled RefLayerRightOffset and ScaledRefLayerBottomOffset are derived as follows:
ScaledRefLayerLeftOffset=scaled_ref_layer_left_offset[rLld]<<1
ScaledRefLayerTopOffset=scaled_ref_layer_top_offset[rLld]<<1
ScaledRefLayerRightOffset=scaled_ref_layer_right_offset[rLld]<<1
ScaledRefLayerBottomOffset=scaled_ref_layer_bottom_offset[rLld]<<1
The variables ScaledRefLayerPicWidthInSamplesY and
ScaledRefLayerPicHeightInSamplesY are derived as follows:

### ScaledRefLayerPicWidthInSamplesY=PicWidthInSamplesY−ScaledRefLayerLeftOffset

### ScaledRefLayerRightOffsetScaledRefLayerPicHeightInSamplesY=PicHeightinSamplesY−ScaledRefLayerTopOffset−ScaledRefLayerBottomOffset

The variables ScaledRefLayerPicWidthInSamplesC and
ScaledRefLayerPicHeightInSamplesC=are derived as follows:

### ScaledRefLayerPicWidthInSamplesC=ScaledRefLayerPicWidthInSamplesY/SubWidthC

### ScaledRelLayerPicHeightInSamplesC=ScaledRefLayerPicHeightInSamplesY/SubHeightC

The variables ScaleFactorX and ScaleFactorY are derived as follows:

### ScaleFactorX=((RefLayerPicWidthInSamplesY<<16)+(ScaledRefLayerPicWidthInSamplesY>>1))

### ScaledRelLayerPicWidthInSamplesY

### ScaleFactor)=((RefLayerPicHeightInSamplesY<<16)+(ScaledRefLayerPicHeightInSamplesY>>1))

### ScaledRelLayerPicHeightInSamplesY

The reference layer sample location xRef16 and yRef16 in units of 116-th sample relative to the top-left sample of the reference layer picture used in resampling, for color component index cldx and sample location (xP, yP) relative to the top-left sample of the color component of the current picture specified by cldx, is derived as:
The variables offsetX and offsetY are derived as follows:
offsetX=ScaledRefLayerLeftOffset/((cldx==0)?1: SubWidthC)
offsetY=ScaledRefLayerTopOffset/((cldx==0)?1: SubHeightC)
The variables phaseX, phaseY, addX and addY are derived as follows:
phaseX=(cldx==0)?(cross_layer_phase_alignment_flag<<1): cross_layer_—phase_alignment_flag
phaseY=(cldx==0)?(cross_layer_phase_alignment_flag<<1): cross_layer_phase_alignment_flag+1
addX=(ScaleFactorX*phaseX+2)>>2
addY=(ScaleFactorY*phaseY+2)>>2
xRef16=(((xP−offsetX)*ScaleFactorX+addX+(1<<11))>>12)−(phaseX<<2)
yRef16=(((yP−offsetY)*ScaleFactorY+addY+(1<<11))>>12)−(phaseY<<2)
In an example embodiment cldx is set to 0 for Y, 1 for Cb and 2 for Cr colour component.

In the current SHVC design an existing layer may use for prediction sample values upsampled from a reference layer picture. When upsampling sample values, spatial scaling factors (for both the horizontal and vertical direction) are determined which is used to determine the exact sample value upsampling process used. Note—if both spatial scale factor are 1 sample values may be directly copied from the reference layer picture.

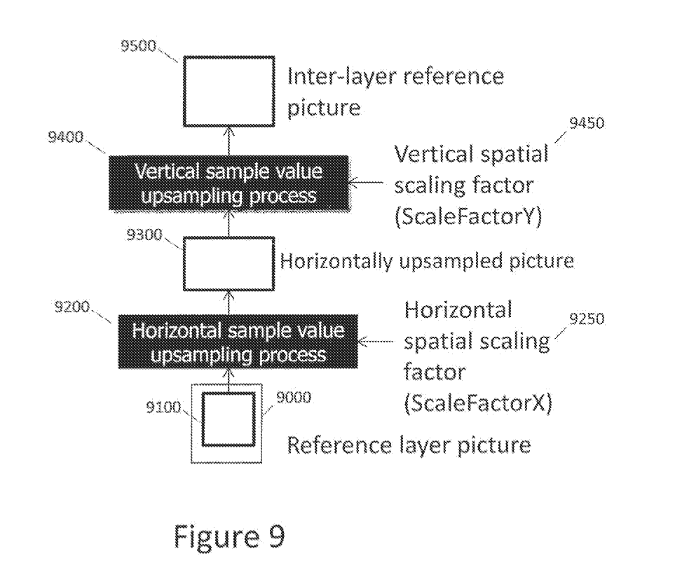

Referring FIG. 9. a subset of sample values 9100 within reference layer picture 9000 is processed by a horizontal upsampler 9200. The horizontal upsampler 9200 uses the input horizontal spatial scaling factor 9250, also denoted as ScaleFactorX, to determine the amount of upsampling to be performed in the horizontal direction and outputs horizontally upsampled picture 9300. Note, ScaleFactorX corresponds to the ratio of upsampled picture width to the width of the subset of sample values being upsampled. The sample values within the horizontally upsampled picture 9300 are further processed by the vertical upsampler 9400. The veritical upsampler 9400 uses the input vertical spatial scaling factor 9450, also denoted as ScaleFactorY, to determine the amount of upsampling to be performed in the vertical direction and outputs the upsampled interlayer reference picture 9500. Note, ScaleFactorY corresponds to the ratio of upsampled picture height to the height of the subset of sample values being upsampled.

In a general design the spatial scaling factors can be greater than 1, requiring that a sample value downsampling process be defined, thereby increasing decoder complexity. To avoid defining a sample downsampling process the sample value spatial scaling factors must be constrained to be less than or equal to 1. In an embodiment this constraint may be expressed as a bitstream conformance requirement on derived variables corresponding to the dimension of the sample value set input to the upsampling process and the dimension of the sample value set output by the upsampling process. In another emobdiment this constaint may be expressed as a bitstream conformance requirement on syntax elements which determine derived variables corresponding to the dimension of the sample value set input to the upsampling process and the dimension of the sample value set output by the upsampling process.

In an embodiment the constraint that the sample value spatial scaling factors must be constrained to be less than or equal to 1 may be expressed as a bitstream conformance requirement. For example a bitstream conformance requirement may be specified as follows: ScaleFactorX and ScaleFactorY, after multiplication with a constant, say C0. shall be less than or equal to 1. In an example C0 is 2⁻¹⁶.

In another embodiment the constraint that the sample value spatial scaling factors must be constrained to be less than or equal to 1 may be expressed as a bitstream conformance requirement by constraining the scaled reference layer luma dimensions of the output interlayer reference picture to be greater than or equal to the luma dimensions of the reference layer subset of sample values used as input. For example a bitstream conformance requirement may be specified as follows:

RefLayerPicWidthInSamplesY<<16)+( ScaledRefLayerPicWidthInSamplesY>>1)) shall be less than or equal to

### ScaledRefLayerPicWidthInSamplesY*C1

RefLayerPicHeightInSamplesY<<16)+(ScaledRefLayerPicHeightInSamplesY>>1)) shall be less than or equal to ScaledRefLayerPicHeightInSamplesY*C1

Where C1 is a constant. In an example C1 is 2¹⁶.

In another embodiment the constraint that the sample value spatial scaling factors must be constrained to be less than or equal to 1 may be expressed as a bitstream conformance requirement by constraining the scaled reference layer luma and chrome dimensions of the output interlayer reference picture to be greater than or equal to the luma and chrome dimensions of the reference layer subset of sample values used as input. For example a bitstream conformance requirement may be specified as follows:

RefLayerPicWidthInSamplesY<<16) ScaledRefLayerPicWi dthInSamplesY>>1)) shall be less than or equal to ScaledRefLayerPicWidthInSamplesY*C2

RefLayerPicHeightInSamplesY<<16) ScaledRefLayerPicHeightInSamplesY>>1)) shall be less than or equal to ScaledRefLayerPicHeightInSamplesY*C2

RefLayerPicWidthInSamplesC<<16) ScaledRefLayerPickWidthInSamplesC>>1)) shall be less than or equal to ScaledRefLayerPicWidthInSamplesC*C2

RefLayerPicHeightInSamplesC<<16) ScaledRefLayerPicHeightInSamplesC>>1)) shall be less than or equal to ScaledRefLayerPicHeightInSamplesC*C2

Where C2 is a constant. In an example C2 is 2^{16.}

In another embodiment the constraint that the sample value spatial scaling factors must be constrained to be less than or equal to 1 may be expressed as a bitstream conformance requirement by constraining the scaled reference layer luma dimensions of the output interlayer reference picture to be greater than or equal to the luma dimensions of the reference layer subset of sample values used as input. For example a bitstream conformance requirement may be specified as follows:

RefLayerPicWidthInSamplesY shall be less than or equal to ScaledRefLayerPicWidthInSamplesY

RefLayerPicHeightInSamplesY shall be less than or equal to ScaledRefLayerPicHeightInSamplesY

In another embodiment the constraint that the sample value spatial scaling factors must be constrained to be less than or equal to 1 may be expressed as a bitstream conformance requirement by constraining the scaled reference layer luma and chroma dimensions of the output interlayer reference picture to be greater than or equal to the luma and chroma dimensions of the reference layer subset of sample values used as input. For example a bitstream conformance requirement may be specified as follows:

RefLayerPicWidthInSamplesY shall be less than or equal to ScaledRefLayerPicWidthInSamplesY

RefLayerPicHeightInSamplesY shall be less than or equal to ScaledRefLayerPicHeightInSamplesY

RefLayerPicWidthInSamplesC shall be less than or equal to ScaledRelLayerPicWidthInSamplesC

RefLayerPicHeightInSamplesC shall be less than or equal to ScaledRefLayerPicHeightInSamplesC

In another embodiment the constraint that the sample value spatial scaling factors must be constrained to be less than or equal to 1 may be expressedas a bitstream conformance requirement. For example a bitstream conformance requirement may be specified as follows:

ScaleFactorX*C3 shall be less than or equal to 1.
ScaleFactorY*C3 shall be less than or equal to 1.
Where C3 is a constant. In an example C3 is 2⁻¹⁶

In another embodiment the constraint that the sample value spatial scaling factors must be constrained to be less than or equal to 1 may be expressed as a bitstream conformance requirement. For example a bitstream conformance requirement may be specified as follows:

For a reference picture layer id rLld, it is a requirement of bitstream conformance that the value of pic_—width_in_—luma_—samples of current layer picture, pic_height_in_luma_samples of current layer picture, chromajormat_idc of current layer, piq_width_in_luma_samples of reference layer picture,
pic_height_in_luma_samples of reference layer picture, chroma_format_idc of reference layer, scaled_ref_layer_left_offset[rLld],
scaled_ref_layer_top_offset[rLld], scaled_ref_layer_right_offset[rLld],
scaled_ref_layer_bottom_offset[rLld], shall be constrained such that the corresponding value of ScaleFactorX and ScaleFactorY after multiplication with a constant C4 shall be less than or equal to 1. In an example C4 is 2⁻¹⁶

In an example embodiment with lura spatial scaling factor of ScaleFactorXLuma and ScaleFactorYLuma for the horizontal and vertical directions, and chroma spatial scaling factor of ScaleFactorXChroma and ScaleFactorYChroma for the horizontal and vertical directions may be derived as follows:

### ScaleFactorXLuma=((RefLayerPicWidthInSamplesY<<16)+(ScaledRefLayerPicWidthinSamplesY>>1))/ScaledRefLayerPicWidthInSamplesY

### ScaleFactorYLuma=((RefLayerPicHeightInSamplesY<<16)+(ScaledRelLayerPicHeightInSamplesY>>1))/Scaled RefLayerPicHeightInSamplesY

### ScaleFactorXChroma=((RefLayerPicWidthInSamplesC<<16)+(ScaledRefLayerPicWidthInSamplesC>>1))/ScaledRefLayerPicWidthInSamplesC

### ScaleFactorYChroma=((RefLayerPicHeightInSamplesC<<16)+Scaled RefLayerPicHeightInSamplesC>>1))/Scaled RefLayerPicHeightInSamplesC

In such an example the following bitstream conformance requirement may be specified:

ScaleFactorXLuma*C4 shall be less than or equal to 1.

ScaleFactorYLuma*C4 shall be less than or equal to 1.

ScaleFactorXChroma*C5 shall be less than or equal to 1.

ScaleFactorYChroma*C5 shall be less than or equal to 1.

Where C4 ,C5 are constants. In an example C4 and C5 are set equal to 2⁻¹⁶ in an example embodiment the spatial scaling constraints may be specifed as listed above but with “less than or equal to” in the above bitstream conformance requirements replaced with “less than”.

In an example embodiment the spatial scaling constraints may be specifed as listed above but with “greater than or equal to” in the above bitstream conformance requirements replaced with “greater than”.

In another embodiment the constraint that the sample value spatial scaling factors must be constrained to be less than or equal to 1 is enforced only when a colour component exists in both the reference and current layer. For example, if the reference layer and current layer chroma formats are 4:2:0 and monochrome respectively then no the spatial scaling factor for the chrome colour components is not defined and the corresponding spartial scaling factor is not enforced.

In the current SHVC design the sample value, spatial scaling factor is the same across different colour components. This disallows the case where reference layer is 4:4:4 with luma resolution W×H, while the enhancement layer is 4:2:0 with luma resolution 2W×2H. To allow for greater functional flexibility, the SHVC design may be modified to use different spatial scaling factors for different colour components. In an example embodiment, the luma spatial scaling factor, the chrome formats of the reference layer and the chroma format of current layer may be used in determining the spatial scaling factor of each colour component. This information in turn may be used for upsampling of each colour component.

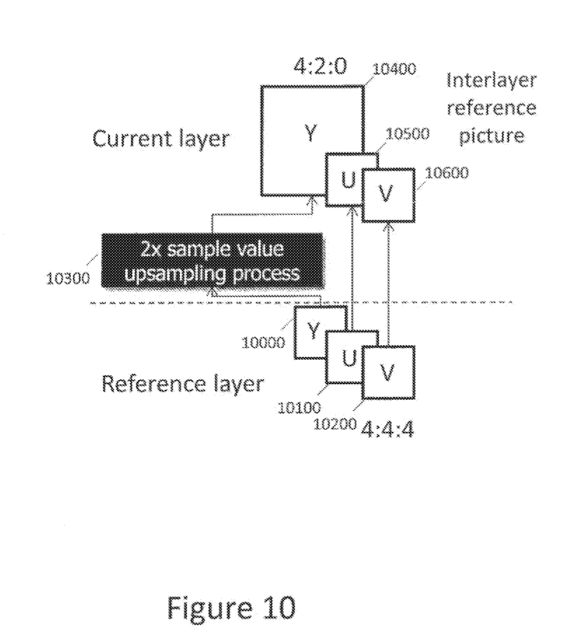

Referring FIG. 10, the reference layer contains 4:4:4 pictures. A decoded reference layer picture with luma and chroma components 10000, 10100 and 10200 is shown in FIG. 10. The current layer contains 4:2:0 pictures with luma spatial resolution being twice the luma resolution of the reference layer picture. The interlayer reference picture may be generated by upsampling only the luma component, using 10300, by a spatial scaling factor of 2 and copying the chrome components. The generated interlayer reference picture contains a luma component 10400 with twice the resolution of the reference layer luma and chrome components 10500, 10600 with same resolution as the reference layer chroma.

In an example embodiment when different chrome formats are used in reference layer and current layer then the reference layer picture chroma component width and height in sample values is modified to take into account the chroma format of the reference layer. The derived variables

RefLayerPicWidthInSamplesC and RefLayerPicHeightInSamplesC are then derived as follows:
The variables RefLayerSubWidthC and RefLayerSubHeightC are set equal to SubWidthC and SubHeightC of the decoded reference layer picture rlPic, respectively.

RefLayerPicWidthInSamplesC=RefLayerPicWidthInSamplesY/RefLayerSubWidthC

RefLayerPicHeightInSamplesC=RefLayerPicHeightInSamplesY/RefLayerSubHeightC

In an example embodiment with luma spatial scaling factor of ScaleFactorX_{L} and ScaleFactorY_{L} for the horizontal and vertical directions, respectively, the corresponding chrome scaling factor ScaleFactorX_{C and ScaleFactorY}_{C} are determined using the chroma formats of the reference and current layer as listed in Table (11) below:

TABLE (11)

| Reference Layer | Current Layer | Chroma spatial scaling factor |
|---|---|---|
| Chroma Format | Chroma Format | (ScaleFactorX_{C}, ScaleFactorY_{C}) |
| 4:4:4 | Monochrome | 0, 0 |
| | 4:2:0 | ScaleFactorX_{L}*2, ScaleFactorY_{L}*2 |
| | 4:2:2 | ScaleFactorX_{L}, ScaleFactorY_{L}*2 |
| | 4:4:4 | ScaleFactorX_{L}, ScaleFactorY_{L} |
| 4:2:2 | Monochrome | 0, 0 |
| | 4:2:0 | ScaleFactorX_{L}*2, ScaleFactorY_{L} |
| | 4:2:2 | ScaleFactorX_{L}, ScaleFactorY_{L} |
| | 4:4:4 | ScaleFactorX_{L}, ScaleFactorY_{L} ÷ 2 |
| 4:2:0 | Monochrome | 0, 0 |
| | 4:2:0 | ScaleFactorX_{L}, ScaleFactorY_{L} |
| | 4:2:2 | ScaleFactorX_{L}÷ 2, ScaleFactorY_{L} |
| | 4:4:4 | ScaleFactorX_{L} ÷ 2,ScaleFactorY_{L}÷ 2 |
| Monochrome | Monochrome | 0, 0 |
| | 4:2:0 | invalid |
| | 4:2:2 | invalid |
| | 4:4:4 | invalid |

In an example embodiment the ScaleFactorX_{L} may be constrained to be less than or equal to 0.5 if ScaleFactorX_{C} is equal to ScaleFactorX_{L}*2.
In an example embodiment the ScaleFactorY_{L} may be constrained to be less than or equal to 0.5 if ScaleFactorY_{C} is equal to ScaleFactorY_{L}*2.

In an example embodiment the upsampling process sets the interlayer reference picture to be equal to decoded reference layer picture if

PicWidthInSamplesY is equal to RefLayerPicWidthInSamplesY,
PicHeightInSamplesY is equal to RefLayerPicHeightInSamplesY,
PicWidthInSamplesC is equal to RefLayerPicWidthInSamplesC,
PicHeightInSamplesC is equal to RefLayerPicHeightInSamplesC, the values of Scaled RefLayerLeftOffset, ScaledRefLayerTopOffset,
ScaledRefLayerRightOffset and ScaledRefLayerBottomOffset are all equal to 0, RefLayerBitDepthY is equal to BitDepthY, and RefLayerBitDepthC is equal to BitDepthC. In other words, if the spatial dimensions of reference layer and current layer luma and chroma components are identical, the scaled reference layer offset values are zero and the bit depth of reference layer and current layer luma and chroma components are identical, then the interlayer reference picture is set to be equal to the decoded reference layer picture. In an alternative embodiment, the upsampling process sets the interlayer reference picture to be equal to the decoded reference layer picture if PicWidth InSamplesY is equal to RefLayerPicWidthInSamplesY, PicHeightlnSarnplesY is equal to RefLayerPicHeightInSamplesY, value of chroma format of decoded reference layer picture is equal to value of chromajormatidc of current layer, the values of Scaled RefLayerLeftOffset, Scaled RefLayerTopOffset, ScaledRefLayerRightOffset and ScaledRefLayerBottomOffset are all equal to 0, RefLayerBitDepthY is equal to BitDepthY, and RefLayerBitDepthC is equal to BitDepthC. In other words, if the spatial dimensions of reference layer and current layer lumna components are identical, the chroma format of the reference layer and the current layer are identical, the scaled reference layer offset values are zero and the bit depth of reference layer and current layer lumna and chroma components are identical, then the interlayer reference picture is set to be equal to the decoded reference layer picture.

In an example embodiment the picture motion field of interlayer reference picture is set equal to the motion field of decoded reference layer picture rlPic if PicWidthInSamplesY is equal to RefLayerPicWidthInSamplesY, PicHeightInSamplesY is equal to RefLayerPicHeightInSamplesY, the values of Scaled RefLayerLeftOffset, Scaled Ref LayerTopOffset, ScaledRefLayerRightOffset and ScaledRefLayerBottomOffset are all equal to 0. In other words, if the spatial dimensions of reference layer and current layer luma components are identical, the scaled reference layer offset values are zero, then the picture motion field of interlayer reference picture is set to be equal to the motion field of the decoded reference layer picture. Note, the interlayer reference picture motion field is set equal to the decoded reference layer picture's motion field even if the reference layer's and current layer's chroma formats are not the same.

In an example embodiment upsampling process the values of the output luma upsampled array, say rsPicSample_{L}, are set equal to the reference layer luma array, say rlPicSample_{L} (i.e for the same array index rlPicSample_{L} and rsPicSample_{L} have the same value) if RefLayerPicWidthInSamplesY is equal to PicWidthInSamplesY, RefLayerPicHeightInSamplesY is equal to PicHeightInSamplesY, the values of ScaledRefLayerLeftOffset, ScaledRefLayerTopOffset, ScaledRefLayerRightOffset and ScaledRefLayerBottomOffset are all equal to 0, and RefLayerBitDepth_{Y} is equal to BitDepth_{Y}. In other words if the spatial dimensions of reference layer and current layer luma components are identical, the scaled reference layer offset values are zero and the bit depth of reference layer and current layer luma components are identical, then the upsampling process copies the sample values from the luma array of the decoded reference layer picture to the luma array of the interlayer reference picture.

In an example embodiment upsampling process the values of the output chrome upsampled array for colour component Cb, say rsPicSample_{Cb}, are set equal to the reference layer chroma array for colour component Cb, say rPicSample_{Cb} (i.e for the same array index rlPicSample_{Cb and rsPicSample}_{Cb} have the same value) if RefLayerPicWidthInSamplesC is equal to PicWidthInSamplesC, RefLayerPicHeightInSamplesC is equal to PicHeightInSamplesC, the values of ScaledRefLayerLeftOffset, Scaled RefLayerTopOffset, ScaledRefLayerRightOffset and ScaledRefLayerBottomOffset are all equal to 0, and RefLayerBitDepth_{C} is equal to BitDepth_{C}. In other words if the spatial dimensions of reference layer and current layer chrome components are identical, the scaled reference layer offset values are zero and the bit depth of reference layer and current layer chroma components are identical, then the upsampling process copies the sample values from the chroma array, for colour component Cb, of the decoded reference layer picture to the chrome array, for colour component Cb, of the interlayer reference picture

In an example embodiment upsampling process the values of the output chrome upsampled array for colour component Cr, say rsPicSample_{Cr}, are set equal to the reference layer chroma array for colour component Cr, say rPicSample_{Cr} (i.e for the same array index rPicSample_{Cr} and rsPicSample_{Cr} have the same value) if RefLayerPicWidthInSamplesC is equal to PicWidthInSamplesC, RefLayerPicHeightInSamplesC is equal to PicHeightInSamplesC, the values of ScaledRefLayerLeftOffset, ScaledRefLayerTopOffset, ScaledRefLayerRightOffset and ScaledRefLayerBottomOffset are all equal to 0, and RefLayerBitDepth_{C} is equal to BitDepth_{C}. In other words if the spatial dimensions of reference layer and current layer chroma components are identical, the scaled reference layer offset values are zero and the bit depth of reference layer and current layer chroma components are identical, then the upsampling process copies the sample values from the chroma array, for colour component Cr, of the decoded reference layer picture to the chroma array, for colour component Cr, of the interlayer reference picture

In an example embodiment, the variables chormaFormatScalingX and chormaFormatScalingY are derived as follows:

The variable ChromaFromatIdc is set equal to the value of chroma_format_idc.
The variable RefLayerChromaFromatIdc is set equal to the value of chroma_format_idc of the decoded reference layer picture.

if (RefLayerChromaFromatIdc==1 && ChromaFromatIdc==3)
chormaFormatScalingX=0.5
chormaFormatScalingY=0.5

elseif (RefLayerChromaFromatIdc==2 && ChromaFromatIdc==3)
chormaFormatScalingX=1
chormaFormatScalingY=0.5

else if (RefLayerChromaFromatIdc==1 && ChromaFromatIdc==2)
chormaFormatScalingX=0.5
chormaFormatScalingY=1

else if (RefLayerChromaFromatIdc==ChromaFromatIdc)
chormaFormatScalingX=1
chormaFormatScalingY=1

else if (RefLayerChromaFromatIdc==3 && ChromaFromatidc==1)
chormaFormatScalingX=2
chormaFormatScalingY=2

else if (RefLayerChromaFromatidc==3 && ChromaFromatIdc==2)
chormaFormatScalingX=1
chormaFormatScalingY=2

else if (RefLayerChromaFromatIdc==2 && ChromaFromatIdc==1)
chormaFormatScalingX=2
chormaForrnatScalingY=1

else
chormaFormatScalingX=0
chormaFormatScalingY=0

The reference layer sample location xRef16 and yRef16 in units of 116-th sample relative to the top-left sample of the reference layer picture used in resampling, for color component index cldx and sample location (xP, yP) relative to the top-left sample of the color component of the current picture specified by cldx, is derived as:

The variables RefLayerSubWidthC and RefLayerSubHeightC are set equal to SubWidthC and SubHeightC of the decoded reference layer picture, respectively.
The variables cX and cY are derived as follows:

cX=(cldx==0)?1 :chromaFormatScalingX

cY=(cldx==0)?1 :chromaFormatScalingY

The variables offsetX and offsetY are derived as follows:

offsetX=ScaledRefLayerLeftOffset/((cldx==0)?1:RefLayerSubWidthC)

offsetY=Scaled RefLayerTopOffset/((cldx==0)?1: RefLayerSubHeightC)

The variables phaseX, phaseY, addX and addY are derived as follows:

phaseX=(cldx==0)?(cross_layer_phase_alignment_flag<<1): cross_layer_phase_alignment_flag

phaseY=(cldx==0)?(cross_layer_phase_alignment_flag<<1): cross_layer_phase_alignment flag+1

addX=(ScaleFactorX*cX*phaseX+2)>>2

addY=(ScaleFactorY*cY*phaseY+2)>>2

xRef16=(((xP−offsetX)*ScaleFactorX*cX+addX+(1<<11))>>12)−(phaseX<<2)

yRef16=(((yP−offsetY)*ScaleFactorY*cY+addY+(1<<11))>>12)−(phaseY<<2)

Note, the reference layer sample location xRef16 and yRef16 now depend on the chroma formats of the current and reference layer.
In an example embodiment upsampling process if chormaFormatScalingX is equal to zero or chormaFormatScalingY is equal to zero then the upsampled chroma arrays do not contain valid data.
In an example embodiment upsampling process if chormaFormatScalingX is equal to zero or chormaFormatScalingY is equal to zero then the upsampled chroma arrays may be initialized to pre-determined values.

In an example embodiment the scaled reference layer offsets scaled_ref_layer_left_offset[scaled_ref_layer_id[i]], scaled_ret_layer_top_offset[scaled_ref_layer_id[i]], scaled_ref_layer_right_offset[scaled_ref_layer_id[i]], scaled_ref_layer_bottom_—offset[scaled _{ref}_layer_—id[i]]of the associated inter-layer picture with nuh_layer_id equal to scaled_ref_layer_id[i ] is signaled independently for every reference layer colour component. In such an example the derived variables ScaleFactorX and ScaleFactorY are determined for each colour component. The spatial scaling factor for individual colour components is then used in the upsampling process for the respective colour components.

In current SHVC design auxiliary pictures are coded in a separate layer from their associated primary pictures.

In some embodiments. it is desirable to have an auxiliary picture with type equal to alpha plane within an access unit be IDR when any of the associated primary picture(s) in that access unit is IDR. The motivation for this being that if random access is performed at the primary picture the corresponding auxiliary picture is also random accessible and decodable with this constraint. In such a case the following bitstream conformance constraint may be imposed:

It is a requirement of bitstream conformance that when any associated primary picture of an auxiliary picture with AuxId[nuh_layer_id] equal to AUX_ALPHA has a nal_unit_type value nalUnitTypeA, equal to IDR_W_RADL or IDR_N_LP, then the nal_unit_type value for the corresponding auxiliary picture within the same access unit with Auxid[nuh_layer_id] equal to AUX_ALPHA shall be equal to nalUnitTypeA
In an alternative embodiment the above IDR alignment constraint is applied to a subset A of auxiliary picture types obtained from the set (alpha, depth, chroma enhancement U, chrome enhancement V, or any other auxiliary picture type) and not just the alpha auxiliary picture type i.e. it is desirable to have auxiliary picture belonging to subset A within an access unit be IDR when any of the associated primary picture(s) within that access unit is IDR.

In another example embodiment the following bitstream conformance constraint may be imposed regarding alignment:

It is a requirement of bitstream conformance that the following constraint is obeyed:
If any associated primary picture of an auxiliary picture with AuxId[nuh_layer_id] equal to AUX_ALPHA has a nal_unit_type value IDR_W_RADL, then the nal_unit_type value for the corresponding auxiliary picture within the same access unit shall be IDR_W_RADL.
Otherwise, If any associated primary picture of an auxiliary picture with AuxId[nuh_layer_id] equal to AUX_ALPHA has a nal_unit_type value IDR_N_LP. then the nal_unit_type value for the corresponding auxiliary picture within the same access unit shall be IDR_N_LP.

In another example embodiment the following bitstream conformance constraint may be imposed regarding alignment:

It is a requirement of bitstream conformance that when associated primary picture of an auxiliary picture with Auxid[nuh_layer_id] equal to AUX_ALPHA has a nal_unit_type equal to IDR_W_RADL or IDR_N_LP, the nal_unit_type value shall be equal to IDR_W_RADL or IDR_N_LP for the auxiliary picture with Auxid[nuh_layer_id] equal to AUX_ALPHA.

In another example embodiment the following bitstream conformance constraint may be imposed regarding alignment:

It is a requirement of bitstream conformance that when associated primary picture of an auxiliary picture with Auxid[nuh_layer_id] equal to AUX_ALPHA has a nal_unit_type equal to BLA_W_RADL or BLA_W_LP or BLA_N_LP, the nal_unit_type value shall be equal to BLA_W_RADL or BLAW_LP or BLA_N_LP for the auxiliary picture with Auxid[nuh_layer_id] equal to AUX_ALPHA.

In another example embodiment the following bistreamn conformance constraint may be imposed regarding alignment:

It is a requirement of bitstream conformance that when associated primary picture of an auxiliary picture with Auxid[nuh_layer_id] equal to AUX_ALPHA has a nal_unit_type equal to CRA_NUT, the nal_unit_type value shall be equal to CRA_NUT for the auxiliary picture with AuxId[nuh_layer_id] equal to AUX_ALPHA.

In another example embodiment the following bitstream conformance constraint may be imposed regarding alignment:

It is a requirement of bitstream conformance that when any associated primary picture of an auxiliary picture with Auxid[nuh_layer_id] equal to AUX_ALPHA has a nal_unit_type equal to IDR_W_RADL or IDR_N_LP, the nal_unit_type value shall be equal to IDR_W_RADL or IDR_N_LP for the auxiliary picture with AuxId[nuh_layer_id] equal to AUX_ALPHA.

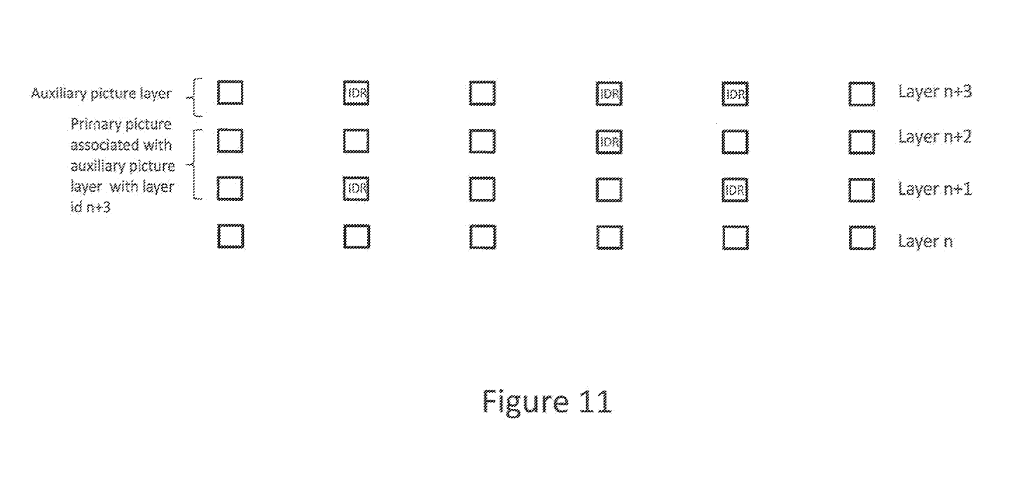

Referring FIG. 11, it shows an example embodiment where Layer n+3 is associated with two primary picture layers n+2 and n+1. If an access unit contains an IDR (either IDR_W_RADL or IDR_N_LP) picture in layer n+2 or n+1 then the corresponding picture in layer n+3 is an IDR picture with the same nal_unit_type as the associated IDR primary picture. Although FIG. 11 shows two associated primary picture layers, in another embodiment only one associated primary picture layer may exist. Similarly in another embodiment more than one layer consisting of auxiliary picture(s) with type equal to alpha plane may exist.

In an example embodiment if an access unit contains IDR_N_LP primary picture then the nal_unit_type of the associated auxiliary picture with the AuxId equal to AUX_ALPHA is IDR_N_LP. Note, if the auxiliary picture with the AuxId equal to AUX_ALPHA has another associated primary picture in the same access unit with nal_unit_type equal to IDR_W_RADL, the nal_unit_type of the auxiliary picture with the AuxId equal to AUX_ALPHA is still IDR_N_LP.

In an example embodiment if an access unit contains IDR_W_RADL primary picture then the nal_unit_type of the associated auxiliary picture with the AuxId equal to AUX_ALPHA is IDR_W_RADL. Note, if the auxiliary picture with the AuxId equal to AUX_ALPHA has another associated primary picture in the same access unit with nal_unit_type equal to IDR_N_LP, the nal_unit_type of the auxiliary picture with the AuxId equal to AUX_ALPHA is still IDR_W_RADL.

In an example embodiment if an access unit contains IDR_N_LP and IDR W RADL primary picture then the nal_unit_type of the associated auxiliary picture with the AuxId equal to AUX_ALPHA can be either IDR_N_LP or IDR_W_RADL.

In some embodiments. it is desirable to have auxiliary picture h type equal to alpha plane within an access unit be IRAP when any of the associated primary picture(s) within that access unit is IRAP. In such a case the following bitstream conformance constraint may be imposed:

It is a requirement of bitstream conformance that when any associated primary picture of an auxiliary picture with Auxid[nuhiayer_id] equal to AUX_ALPHA is an RAP picture, then the corresponding auxiliary picture within the same access unit with AuxId[nuhiayer_id] equal to AUX_ALPHA shall be an IRAP picture

In an alternative embodiment the above IRAP alignment constraint is applied to a subset B of auxiliary picture types obtained from the set (alpha, depth, chroma enhancement U, chroma enhancement V, or any other auxiliary picture type) and not just the alpha auxiliary picture type i.e. it is desirable to have auxiliary picture belonging to subset B within an access unit be IRAP when any of the associated primary picture(s) within that access unit is IRAP.

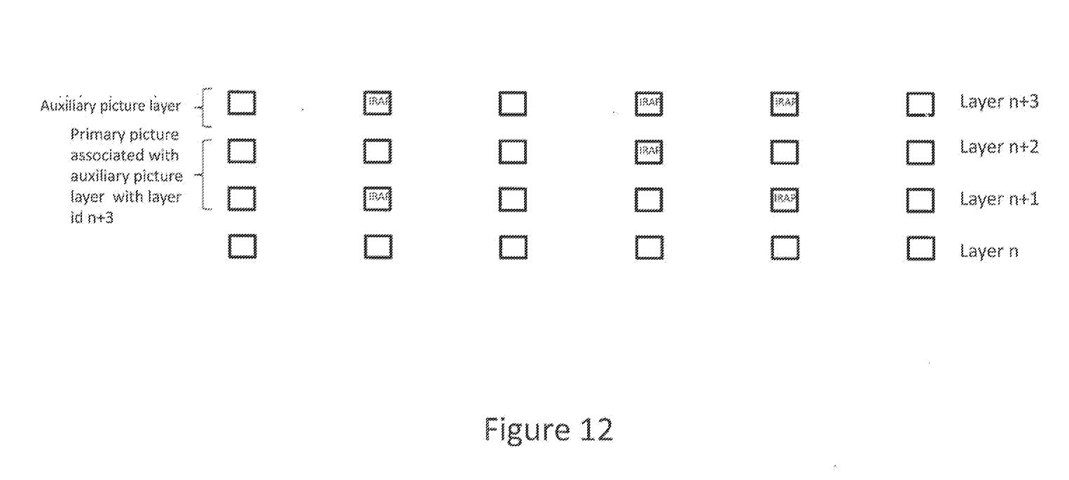

Referring FIG. 12, it shows an example embodiment where Layer n+3 is associated with two primary picture layers n+2 and n+1. If an access unit contains an IRAP picture in layer n+2 or n+1 then the corresponding picture In layer n+3 is an IRAP picture with the same nal_unit_type as the associated IRAP primary picture. Although FIG. 12 shows two associated primary picture layers, in another embodiment only one associated primary picture layer may exist. Similarly in another embodiment more than one layer consisting of auxiliary picture(s) with type equal to alpha plane may exist.

In an example embodiment, when an auxiliary picture with type equal to alpha plane has multiple associated primary pictures within an access unit that are IRAP then the nal_unit_type of the associated auxiliary picture with type equal to alpha plane is determined using a prod-determined set of rules based on the nal_unit_types of the associated primary pictures within the access unit. Table (12) represents one such rule:

TABLE 12

| | | | | | | nal_unit_type |
|---|---|---|---|---|---|---|
| | | | | | | for auxiliary |
| | | | | | | picture with |
| | | | | | | type equal to |
| BLA_W_LP | BLA_W_RADL | BLA_N_LP | CRA_NUT | IDR_W_RADL | IDR_N_LP | alpha plane |
| X | X | X | X | X | 1 | IDR_N_LP |
| X | X | X | X | 1 | 0 | IDR_W_RADL |
| X | X | X | 1 | 0 | 0 | CRA_NUT |
| X | X | 1 | 0 | 0 | 0 | BLA_N_LP |
| X | 1 | 0 | 0 | 0 | 0 | BLA_W_RADL |
| 1 | 0 | 0 | 0 | 0 | 0 | BLA_W_LP |

Referring Table (12), If an access unit contains associated primary pictures with nal_unit_type corresponding to the column labels and a row entry of 1, and also contains no associated primary pictures with nal_unit_type corresponding to the column labels and a row entry of 0, then the corresponding auxiliary picture with type equal to alpha plane nal_unit_type is listed in the rightmost column of that row. A notation of X in the row indicates that associated primary pictures with nal_unit_type corresponding to the corresponding column labels may or may not be present within the access unit being considered.

In some embodiments. it is desirable to have an auxiliary picture with type equal to alpha plane be IDR or BLA when any of the associated primary picture within that access unit is an INRs or BLA, respectively. Note in this embodiment a CRA picture in the primary picture layer does not constraint the auxiliary picture with type equal to alpha plane to be a CRA picture.

In an example the above IDR and BLA alignment constraint is applied to a subset A of auxiliary picture types obtained from the set (alpha, depth, chroma enhancement U, chrorna enhancement V, or any other auxiliary picture type) and not just the alpha auxiliary picture type i.e, it is desirable to have an auxiliary picture belonging to subset A be an IDR or CRA when any of the associated primary picture(s) within that access unit is an IDR or CRA respectively.

In an example embodiment, the luma sample array width and height of an auxiliary picture with type equal to alpha plane is constrained to be equal to the luma sample array width and height, respectively, of the associated primary picture(s).

In an example embodiment, the chrome sample array width and height of an auxiliary picture with type equal to alpha plane is constrained to be equal to the chrome sample array width and height, respectively, of the associated primary picture(s).

As previously described, scalable video coding is a technique of encoding a video bitstream that also contains one or more subset bitstreams. A subset video bitstream may be derived by dropping packets from the larger video to reduce the bandwidth required for the subset bitstream. The subset bitstream may represent a lower spatial resolution (smaller screen), lower temporal resolution (lower frame rate), or lower quality video signal. For example, a video bitstream may include 5 subset bitstreams, where each of the subset bitstreams adds additional content to a base bitstream. HannukSEIa, et al., “Test Model for Scalable Extensions of High Efficiency Video Coding (HEVC)” JCTVC-L0453, Shanghai, October 2012, is hereby incorporated by reference herein in its entirety. Chen, et al., “SHVC Draft Text 1,” JCTVC-L1008, Geneva, March, 2013, is hereby incorporated by reference herein in its entirety.

As previously described, multi-view video coding is a technique of encoding a video bitstream that also contains one or more other bitstreams representative of alternative views. For example, the multiple views may be a pair of views for stereoscopic video, For example, the multiple views may represent multiple views of the same scene from different viewpoints. The multiple views generally contain a large amount of inter-view statistical dependencies, since the images are of the same scene from different viewpoints.

Therefore, combined temporal and inter-view prediction may achieve efficient multi-view encoding. For example, a frame may be efficiently predicted not only from temporally related frames, but also from the frames of neighboring viewpoints. HannukSEIa, et al., “Common specification text for scalable and multi-view extensions,” JCTVC-L0452, Geneva, January 2013, is hereby incorporated by reference herein in its entirety. Tech, et. al. “MV-HEVC Draft Text 3 (ISO/IEC 23008-2:201x/PDAM2),” JCT3V-C1004_d3, Geneva, January 2013, is hereby incorporated by reference herein in its entirety.

In another embodiment one or more of the syntax elements may be signaled using a known fixed number of bits instead of u(v) instead of ue(v). For example they could be signaled using u(8) or u(16) or u(32) or u(64), etc.

In another embodiment one or more of these syntax element could be signaled with ue(v) or some other coding scheme instead of fixed number of bits such as u(v) coding.

In another embodiment the names of various syntax elements and theft semantics may be altered by adding a plus1 or plus2 or by subtracting a minus1 or a minus2 compared to the described syntax and semantics.

In yet another embodiment various syntax elements included in the output layer sets SEI message may be signaled per picture or at other frequency anywhere in the bitstream. For example they may be signaled in slice segment header, pps/ sps/ vps/ adaptation parameter set or any other parameter set or other normative part of the bitstream.

In yet another embodiment various syntax elements may be signaled per picture or at other frequency anywhere in the bitstream. For example they may be signaled in slice segment header, pps/ sps/ vps/ adaptation parameter set or any other parameter set or other normative part of the bitstream.

In yet another embodiments all the concepts defined in this invention related to output layer sets could be applied to output operation points as defined in JCTVC-L0452 and JCTVC-L0453 and or to operation points as defined in JCTVC-L1003.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in andor performed using hardware. For example, one or more of the methods or approaches described herein may be implemented in andor realized using a chipset, are ASIC, a large-scale integrated circuit (LSI) or integrated circuit, etc.

Each of the methods disclosed herein comprises one or more steps or actions for achieving the described method. The method steps andor actions may be interchanged with one another andor combined into a single step without departing from the scope of the claims. In other words, unless a specific order of steps or actions is required for proper operation of the method that is being described, the order andor use of specific steps andor actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

I/We claim:

1. A system for decoding a video bitstream comprising:
(a) receiving a piurality of frames of said video bitstre,am suitable for scalable video coding;
(b) data together with said video bitstream that that includes constraints for said scalable video coding.
